(19) United States
(12) Patent Application Publication
(10) Pub. No.: US 2006/0231462 A1
(43) Pub. Date: Oct. 19, 2006

(54) System for improving crude oil

(76) Inventor: Raymond Ford Johnson, White Oak, TX (US)

Correspondence Address: CARSTENS & CAHOON, LLP, P O BOX 802334, DALLAS, TX, 75380, US

(21) Appl. No.: 11/405,389

(22) Filed: Apr. 17, 2006

Related U.S. Application Data
(60) Provisional application No. 60/672,187, filed on Apr. 15, 2005.

(51) Int. Cl. C10G 9/00; C10G 9/26; C10G 9/42; B01D 29/00; B01D 21/24

(52) U.S. Cl. 208/125; 210/767; 210/420; 210/416.1; 208/106

(57) ABSTRACT

Crude oil can be refined through a filtration media. Cavitation bubbles having localized areas of very high temperatures and pressures may be created thereby causing several physical and chemical phenomena, including thermal cracking of carbon-carbon bonds as the crude moves through the flux cartridge membrane. Heavy hydrocarbons are residues are thereby cracked into smaller lowering boiling molecules having a higher API gravity. Once the relatively smaller hydrocarbons pass through the flux cartridge membrane into the flux cartridge, the effluent can be routed to a second separator annulus. It should also be pointed out that lighter hydrocarbons formed can volatilize and special provisions may be needed to efficiently capture these gases.

### PRIORITY CLAIM

This application claims the benefit of and priority to U.S. Provisional Application Ser. No. 60/672,187, which was filed on Apr. 15, 2005, which claims the benefit of and priority to co-pending U.S. patent application Ser. No. 11/042,235 which was filed on Jan. 25, 2005, which claims the benefit of and priority to U.S. patent application Ser. No. 10/820,538, filed on Apr. 8, 2004, which claims the benefit of and priority to U.S. Provisional Application No. 60/540,492, filed Jan. 30, 2004, the disclosures of which are incorporated herein by reference.

### BACKGROUND OF THE INVENTION

1. Technical Field

The present invention relates to a system for improving crude oil and specifically to a method that does not involve the use of traditional distillation. Instead, the crude oil is filtered through a tight filtration media. The pressures and temperatures produced within the media break the longer hydrocarbon chains within the crude oil mixture, producing a more valuable hydrocarbon profile.

2. Description of Related Art

Petroleum is perhaps the most important natural resource. It is produced from underground formations. Sometimes these formations are produced through land based wells while others are produced through offshore platforms. When the petroleum is initially produced, it is often referred to as crude oil, because it contains a mixture of both valuable and less valuable hydrocarbons. Crude oil is refined to break down the less valuable hydrocarbons into a more valuable product, such as gasoline. The refining process adds tremendous value to the produced oil, but is a complicated and expensive process. The cost of a refining plant can easily exceed one billion dollars. Therefore, a need exists for a simpler and less expensive method for achieving many of the same results as traditional petroleum refining.

Petroleum refining has evolved continuously in response to changing consumer demand for better and different products. The original requirement was to produce kerosene as a cheaper and better source of light than whale oil. The development of the internal combustion engine led to the production of gasoline and diesel fuels. The evolution of the airplane created a need first for high-octane aviation gasoline and then for jet fuel, a sophisticated form of the original product, kerosene. Present-day refineries produce a variety of products including many required as feedstock for the petrochemical industry.

Distillation Processes. The first refinery, opened in 1861, produced kerosene by simple atmospheric distillation. Its by-products included tar and naphtha. It was soon discovered that high-quality lubricating oils could be produced by distilling petroleum under vacuum. However, for the next 30 years kerosene was the product consumers wanted. Two significant events changed this situation: (1) invention of the electric light decreased the demand for kerosene, and (2) invention of the internal combustion engine created a demand for diesel fuel and gasoline (naphtha).

Thermal Cracking Processes. With the advent of mass production and World War I, the number of gasoline-powered vehicles increased dramatically and the demand for gasoline grew accordingly. However, distillation processes produced only a certain amount of gasoline from crude oil. In 1913, the thermal cracking process was developed, which subjected heavy fuels to both pressure and intense heat, physically breaking the large molecules into smaller ones to produce additional gasoline and distillate fuels. Visbreaking, another form of thermal cracking, was developed in the late 1930's to produce more desirable and valuable products.

Catalytic Processes. Higher-compression gasoline engines required higher-octane gasoline with better antiknock characteristics. The introduction of catalytic cracking and polymerization processes in the mid- to late 1930's met the demand by providing improved gasoline yields and higher octane numbers.

Alkylation, another catalytic process developed in the early 1940's, produced more high-octane aviation gasoline and petrochemical feedstock for explosives and synthetic rubber. Subsequently, catalytic isomerization was developed to convert hydrocarbons to produce increased quantities of alkylation feedstock. Improved catalysts and process methods such as hydrocracking and reforming were developed throughout the 1960's to increase gasoline yields and improve antiknock characteristics. These catalytic processes also produced hydrocarbon molecules with a double bond (alkenes) and formed the basis of the modern petrochemical industry.

TREATMENT PROCESSES. Throughout the history of refining, various treatment methods have been used to remove nonhydrocarbons, impurities, and other constituents that adversely affect the properties of finished products or reduce the efficiency of the conversion processes. Treating can involve chemical reaction and/or physical separation. Typical examples of treating are chemical sweetening, acid treating, clay contacting, caustic washing, hydrotreating, drying, solvent extraction, and solvent dewaxing. Sweetening compounds and acids desulfurize crude oil before processing and treat products during and after processing.

Crude oils are complex mixtures containing many different hydrocarbon compounds that vary in appearance and composition from one oil field to another. Crude oils range in consistency from water to tar-like solids, and in color from clear to black. An “average” crude oil contains about 84% carbon, 14% hydrogen, 1%-3% sulfur, and less than 1% each of nitrogen, oxygen, metals, and salts. Crude oils are generally classified as paraffinic, naphthenic, or aromatic, based on the predominant proportion of similar hydrocarbon molecules. Mixed-base crudes have varying amounts of each type of hydrocarbon. Refinery crude base stocks usually consist of mixtures of two or more different crude oils.

Relatively simple crude oil assays are used to classify crude oils as paraffinic, naphthenic, aromatic, or mixed. One assay method (United States Bureau of Mines) is based on distillation, and another method (UOP “K” factor) is based on gravity and boiling points. More comprehensive crude assays determine the value of the crude (i.e., its yield and quality of useful products) and processing parameters. Crude oils are usually grouped according to yield structure.

Crude oils are also defined in terms of API (American Petroleum Institute) gravity. The higher the API gravity, the lighter the crude. For example, light crude oils have high API gravities and low specific gravities. Crude oils with low carbon, high hydrogen, and high API gravity are usually rich in paraffins and tend to yield greater proportions of gasoline and light petroleum products; those with high carbon, low hydrogen, and low API gravities are usually rich in aromatics.

Crude oils that contain appreciable quantities of hydrogen sulfide or other reactive sulfur compounds are called “sour.” Those with less sulfur are called “sweet.” Some exceptions to this rule are West Texas crudes, which are always considered “sour” regardless of their H₂S content, and Arabian high-sulfur crudes, which are not considered “sour” because their sulfur compounds are not highly reactive.

BASICS OF HYDROCARBON CHEMISTRY. Crude oil is a mixture of hydrocarbon molecules, which are organic compounds of carbon and hydrogen atoms that may include from one to 60 carbon atoms. The properties of hydrocarbons depend on the number and arrangement of the carbon and hydrogen atoms in the molecules. The simplest hydrocarbon molecule is one carbon atom linked with four hydrogen atoms: methane. All other variations of petroleum hydrocarbons evolve from this molecule.

Hydrocarbons containing up to four carbon atoms are usually gases, those with 5 to 19 carbon atoms are usually liquids, and those with 20 or more are solids. The refining process uses chemicals, catalysts, heat, and pressure to separate and combine the basic types of hydrocarbon molecules naturally found in crude oil into groups of similar molecules. The refining process also rearranges their structures and bonding patterns into different hydrocarbon molecules and compounds. Therefore it is the type of hydrocarbon (paraffinic, naphthenic, or aromatic) rather than its specific chemical compounds that is significant in the refining process. FIG. 1A provides an illustration of a typical crude oil profile based on the molecular weight. Napthas have the lowest molecular weight, while residiums have the highest molecular weight. Also, note the correlation between molecular weight and boiling point. FIG. 1B provides a table that outlines the various profiles of crude oil produced around the world. For example, Saudi-Heavy has a very low API of 28 while Nigerian-Light has an API of 36. Oils with higher API values are more valuable. For example, heavy oil might be valued at $35 per barrel. In contrast, light oil with few contaminants might be valued at $55 per barrel. The $20 spread between these values is caused by the additional cost of refining required for the heavy crude oil. Thus, a need exists for an economical system for improving the quality of heavy oils such as those found in Saudi Arabia.

Paraffins. The paraffinic series of hydrocarbon compounds, illustrated in FIG. 2A found in crude oil have the general formula CₙH₂.+₂ and can be either straight chains (normal) or branched chains (isomers) of carbon atoms. The lighter, straight-chain paraffin molecules are found in gases and paraffin waxes. Examples of straight-chain molecules are methane, ethane, propane, and butane (gases containing from one to four carbon atoms), and pentane and hexane (liquids with five to six carbon atoms). The branched-chain (isomer) paraffins are usually found in heavier fractions of crude oil and have higher octane numbers than normal paraffins. These compounds are saturated hydrocarbons, with all carbon bonds satisfied, that is, the hydrocarbon chain carries the full complement of hydrogen atoms.

Aromatics are unsaturated ring-type (cyclic) compounds, such as those shown in FIG. 2B, which react readily because they have carbon atoms that are deficient in hydrogen. All aromatics have at least one benzene ring (a single-ring compound characterized by three double bonds alternating with three single bonds between six carbon atoms) as part of their molecular structure. Naphthalenes are fused double-ring aromatic compounds. The most complex aromatics, polynuclears (three or more fused aromatic rings), are found in heavier fractions of crude oil.

Naphthenes, such as those shown in FIG. 2C, are saturated hydrocarbon groupings with the general formula CₙH₂ₙ, arranged in the form of closed rings (cyclic) and found in all fractions of crude oil except the very lightest. Single-ring naphthenes (monocycloparaffins) with five and six carbon atoms predominate, with two-ring naphthenes (dicycloparaffins) found in the heavier ends of naphtha.

Other Hydrocarbons-Alkenes are mono-olefins with the general formula CₙH₂n and contain only one carbon-carbon double bond in the chain. Alkenes are illustrated in FIG. 2D. The simplest alkene is ethylene, with two carbon atoms joined by a double bond and four hydrogen atoms. Olefins are usually formed by thermal and catalytic cracking and rarely occur naturally in unprocessed crude oil.

Dienes and Alkynes. Dienes, also known as diolefins, have two carbon-carbon double bonds. The alkynes, such as acetylene shown in FIG. 2E, are another class of unsaturated hydrocarbons, and have a carbon-carbon triple bond within the molecule. Both these series of hydrocarbons have the general formula CₙH₂ₙ₋₂. Diolefins such as 1,2-butadiene and 1,3-butadiene, and alkynes such as acetylene, occur in C₅ and lighter fractions from cracking. The olefins, diolefins, and alkynes are said to be unsaturated because they contain less than the amount of hydrogen necessary to saturate all the valences of the carbon atoms. These compounds are more reactive than paraffins or naphthenes and readily combine with other elements such as hydrogen, chlorine, and bromine.

Nonhydrocarbons. Sulfur Compounds. Sulfur may be present in crude oil as hydrogen sulfide (H₂S), as compounds (e.g. mercaptans, sulfides, disulfides, thiophenes, etc.) or as elemental sulfur. Each crude oil has different amounts and types of sulfur compounds, but as a rule the proportion, stability, and complexity of the compounds are greater in heavier crude-oil fractions. Hydrogen sulfide is a primary contributor to corrosion in refinery processing units. Other corrosive substances are elemental sulfur and mercaptans. Moreover, the corrosive sulfur compounds have an obnoxious odor.

Pyrophoric iron sulfide results from the corrosive action of sulfur compounds on the iron and steel used in refinery process equipment, piping, and tanks. The combustion of petroleum products containing sulfur compounds produces undesirables such as sulfuric acid and sulfur dioxide. Catalytic hydrotreating processes such as hydrodesulfurization remove sulfur compounds from refinery product streams. Sweetening processes either remove the obnoxious sulfur compounds or convert them to odorless disulfides, as in the case of mercaptans.

Oxygen Compounds. Oxygen compounds such as phenols, ketones, and carboxylic acids occur in crude oils in varying amounts.

Nitrogen Compounds. Nitrogen is found in lighter fractions of crude oil as basic compounds, and more often in heavier fractions of crude oil as nonbasic compounds that may also include trace metals such as copper, vanadium, and/or nickel. Nitrogen oxides can form in process furnaces. The decomposition of nitrogen compounds in catalytic cracking and hydrocracking processes forms ammonia and cyanides that can cause corrosion.

Trace Metals. Metals, including nickel, iron, and vanadium are often found in crude oils in small quantities and are removed during the refining process. Burning heavy fuel oils in refinery furnaces and boilers can leave deposits of vanadium oxide and nickel oxide in furnace boxes, ducts, and tubes. It is also desirable to remove trace amounts of arsenic, vanadium, and nickel prior to processing as they can poison certain catalysts.

Salts. Crude oils often contain inorganic salts such as sodium chloride, magnesium chloride, and calcium chloride in suspension or dissolved in entrained water (brine). These salts must be removed or neutralized before processing to prevent catalyst poisoning, equipment corrosion, and fouling. Salt corrosion is caused by the hydrolysis of some metal chlorides to hydrogen chloride (HCl) and the subsequent formation of hydrochloric acid when crude is heated. Hydrogen chloride may also combine with ammonia to form ammonium chloride (NH₄Cl), which causes fouling and corrosion.

PETROLEUM REFINING OPERATIONS. Traditional petroleum refining begins with the distillation, or fractionation, of crude oils into separate hydrocarbon groups. The resultant products are directly related to the characteristics of the crude processed. Most distillation products are further converted into more usable products by changing the size and structure of the hydrocarbon molecules through cracking, reforming, and other conversion processes. These converted products are then subjected to various treatment and separation processes such as extraction, hydrotreating, and sweetening to remove undesirable constituents and improve product quality. Integrated refineries incorporate fractionation, conversion, treatment, and blending operations and may also include petrochemical processing.

Fractionation (distillation) is the separation of crude oil in atmospheric and vacuum distillation towers into groups of hydrocarbon compounds of differing boiling-point ranges called “fractions” or “cuts.”

Conversion processes change the size and/or structure of hydrocarbon molecules. These processes include: Decomposition (dividing) by thermal and catalytic cracking; Unification (combining) through alkylation and polymerization; and Alteration (rearranging) with isomerization and catalytic reforming.

Treatment processes are intended to prepare hydrocarbon streams for additional processing and to prepare finished products. Treatment may include the removal or separation of aromatics and naphthenes as well as impurities and undesirable contaminants. Treatment may involve chemical or physical separation such as dissolving, absorption, or precipitation using a variety and combination of processes including desalting, drying, hydrodesulfurizing, solvent refining, sweetening, solvent extraction, and solvent dewaxing.

Formulating and Blending is the process of mixing and combining hydrocarbon fractions, additives, and other components to produce finished products with specific performance properties.

Auxiliary operations and facilities include: steam and power generation; process and fire water systems; flares and relief systems; furnaces and heaters; pumps and valves; supply of steam, air, nitrogen, and other plant gases; alarms and sensors; noise and pollution controls; sampling, testing, and inspecting; and laboratory, control room, maintenance, and administrative facilities.

CRUDE OIL DISTILLATION (FRACTIONATION). FIGS. 3A and 3B illustrate a traditional distillation system 10. The first step in the refining process is the separation of crude oil into various fractions or straight-run cuts by distillation in atmospheric 12 and vacuum 14 towers. The main fractions or “cuts” obtained have specific boiling-point ranges and can be classified in order of decreasing volatility into gases, light distillates, middle distillates, gas oils, and residuum.

Atmospheric Distillation Tower. At the refinery, the desalted crude feedstock is preheated using recovered process heat. The feedstock then flows to a direct-fired crude charge heater where it is fed into the vertical distillation column just above the bottom, at pressures slightly above atmospheric and at temperatures ranging from 650° to 700° F. (heating crude oil above these temperatures may cause undesirable thermal cracking). All but the heaviest fractions flash into vapor. As the hot vapor rises in the tower, its temperature is reduced. Heavy fuel oil or asphalt residue 16 is taken from the bottom. At successively higher points on the tower, the various major products including lubricating oil, heating oil, kerosene, gasoline, and uncondensed gases (which condense at lower temperatures) are drawn off.

The fractionating tower 12, which is typically a steel cylinder about 120 feet high, contains horizontal steel trays for separating and collecting the liquids. At each tray, vapors from below enter perforations and bubble caps. They permit the vapors to bubble through the liquid on the tray, causing some condensation at the temperature of that tray. An overflow pipe drains the condensed liquids from each tray back to the tray below, where the higher temperature causes re-evaporation. The evaporation, condensing, and scrubbing operation is repeated many times until the desired degree of product purity is reached. Then side streams from certain trays are taken off to obtain the desired fractions. Products ranging from uncondensed fixed gases at the top to heavy fuel oils at the bottom can be taken continuously from a fractionating tower 12. Steam is often used in towers to lower the vapor pressure and create a partial vacuum. The distillation process separates the major constituents of crude oil into so-called straight-run products. Sometimes crude oil is “topped” by distilling off only the lighter fractions, leaving a heavy residue that is often distilled further under high vacuum.

Vacuum Distillation Tower. In order to further distill the residuum or topped crude from the atmospheric tower at higher temperatures, reduced pressure is required to prevent thermal cracking. The process takes place in one or more vacuum distillation towers 14. The principles of vacuum distillation resemble those of fractional distillation and, except that larger-diameter columns are used to maintain comparable vapor velocities at the reduced pressures, the equipment is also similar. The internal designs of some vacuum towers are different from atmospheric towers in that random packing and demister pads are used instead of trays. A typical first-phase vacuum tower may produce gas oils, lubricating-oil base stocks, and heavy residual for propane deasphalting. A second-phase tower operating at lower vacuum may distill surplus residuum from the atmospheric tower 12, which is not used for lube-stock processing, and surplus residuum from the first vacuum tower not used for deasphalting. Vacuum towers are typically used to separate catalytic cracking feedstock from surplus residuum.

The cost of building a typical refining plant is staggering and no new refineries have been built in the U.S. since the 1970s. A refinery also tends to be inflexible once designed. The design, for example, is often optimized for a particular feedstock. Moreover, heavy crudes may need to be blended with light crudes or other compounds so that crude can be pumped through a pipeline to a fixed location refinery. In addition, refineries are expensive to operate with all of the energy requirements that the boilers at the various fractionation towers require, catalyst beds that get fouled, heat exchangers that get fouled, etc. These processing units require periodic preventive maintenance activities in order to permit continued operational performance without an unexpected shutdown. Much of the required preventive maintenance cannot be performed during the operation of the various refinery untis, thus the entire refinery must be shut down for a maintenance period every so often. These maintenance periods are known in the industry as turnarounds or shutdowns. These turnarounds can require downtime of 2 to 6 weeks or more and can occur as often as every 18 months. These expensive turnarounds require extensive planning and as well as manpower resources. Further, it should be noted that while the refinery is shut down, it is not producing any income. Therefore, a need exists for a less expensive and flexible system to improve or enhance crude oil. The system must be flexible enough to improve or enhance a variety of crude oil profiles. The system should cost less to build and operate. Further, the system should be transportable to allow its decentralized use. The system should inexpensively permit crudes to be converted to lighter gravity crudes with more commercial value.

### SUMMARY OF THE INVENTION

The present invention discloses a method and apparatus for enhancing crude oil. Specifically, the present invention includes a pneumatic pressure source which transports crude into a separator. The crude is placed under pressure sufficient to drive the crude into and through the filter media within the separator. As the crude passes through the filtration media, it experiences cavitation effects. The cavitation effects impart mechanical and thermal energy that assists in breaking or cracking the hydrocarbons into more valuable lighter hydrocarbons. The treated crude can then be transported to a collection tank. The particulate matter or build-up material retained on and within the filter media may be removed by the instantenous reverse pressurization of the separator thereby forcing the build-up material away from contact with the filter media and into a concentrator or setting tank, either of which can dewater, dry, and/or further process the build-up material as desired. The present invention thereby addresses the need for a less expensive and more flexible system for enhancing crude oil. In one aspect, the invention transforms crude oil having an API gravity of 26 into crude oil having an API gravity of 35.

The present invention also discloses a novel poppet valve design which insures leak proof function and can be controlled electronically via standard control inputs or pneumatically by the application of positive or negative pressure. The present invention also discloses a novel separator design which utilizes kinetics and cavitation physics to increase filtration efficiency, causing the cracking of hydrocarbons. The above as well as additional features and advantages will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A and 1B illustrate the hydrocarbon profiles of crude oil;

FIGS. 2A to 2E illustrate various hydrocarbon compounds found in crude oil;

FIGS. 3A and 3B illustrate a prior art refining process for crude oil;

FIG. 4 is a schematic diagram illustrating the interaction of the functional components of the system as depicted in accordance with one embodiment of the present invention;

FIG. 5 is a schematic diagram illustrating the pneumatic pressure pump in more detail;

FIG. 6 is a cross-section view of the filter membrane of the flux cartridge inside the annulus of a separator;

FIG. 7 is a schematic view illustrating the pneumatic ejector pump in more detail;

FIG. 8A is a rear view pictorial diagram of a preferred embodiment of the system apparatus;

FIG. 8B is a front view pictorial diagram of the system apparatus;

FIG. 9A is an exploded perspective view diagram of a separator filter pod;

FIG. 9B is an exploded perspective view of an alternative embodiment of a separator filter pod;

FIG. 9C is a perspective view of the media housing tube;

FIG. 10A is an end on view of the top of the valve heads;

FIG. 10B is an end on view of the bottom of the valve heads;

FIG. 11A is an end on view of the top of the first transition plate;

FIGURE 11B is an end on view of the bottom of the first transition plate;

FIG. 12A is an end on view of the top of the second transition plate;

FIG. 12B is an end on view of the bottom of the second transition plate;

FIG. 13A is an end on view of the top of the third transition plate;

FIG. 13B is an end on view of the bottom of the third transition plate;

FIG. 14A is an end on view of the top of the main body of the separator filter pod;

FIG. 14B is an end on view of the bottom of the main body of the separator filter pod;

FIG. 15A is an end on view of the top of the fourth transition plate;

FIG. 15B is an end on view of the bottom of the fourth transition plate;

FIG. 16A is an end on view of the top of the fifth transition plate;

FIG. 16B is an end on view of the bottom of the fifth transition plate;

FIG. 17 is a cross section schematic diagram of the poppet valves and poppet valve heads;

FIG. 18 is a side pictorial view of a flux cartridge;

FIG. 19 is a cross section schematic diagram illustrating a concentrator in more detail;

FIG. 20 illustrates the flow of crude oil through the filtration media;

FIGS. 21A to 21D provide a more detailed view of the tortuous path the crude oil travels as it is forced through the filtration media;

FIG. 22 illustrates a single stage of the crude oil enhancement process in accordance with the present invention;

FIGS. 23A to 23C illustrate the changing crude oil profile after subsequent filtration cycles;

FIG. 24 provides a schematic of a multi-stage filtration enhancement process;

FIGS. 25 to 27 show the use of multiple stages in series, parallel and in combination; and

FIG. 28 shows the use of heat to improve the viscosity of the crude oil as it passes through the filtration stages.

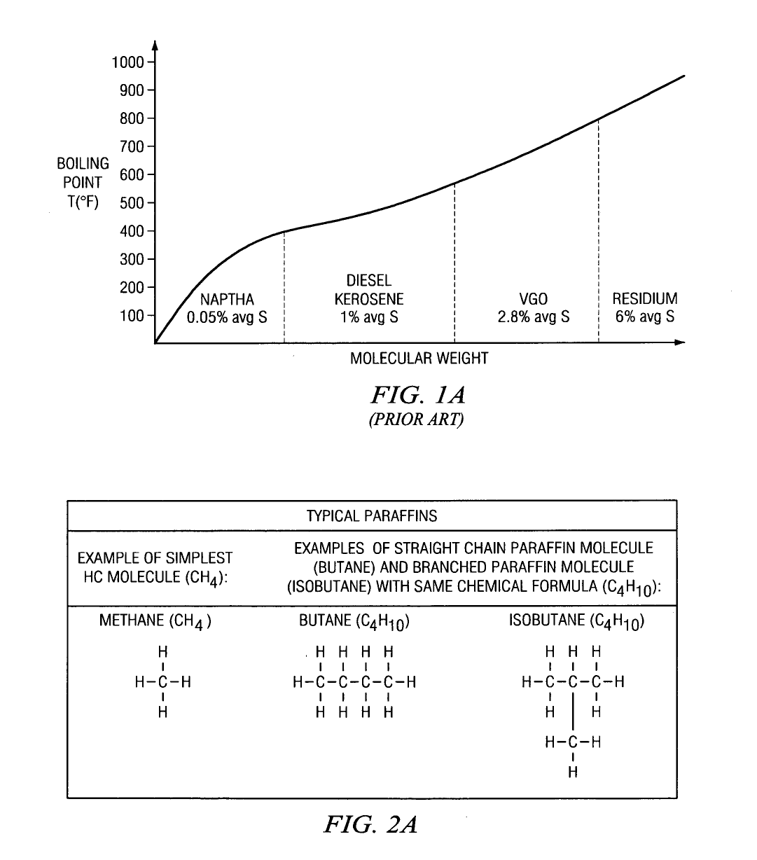

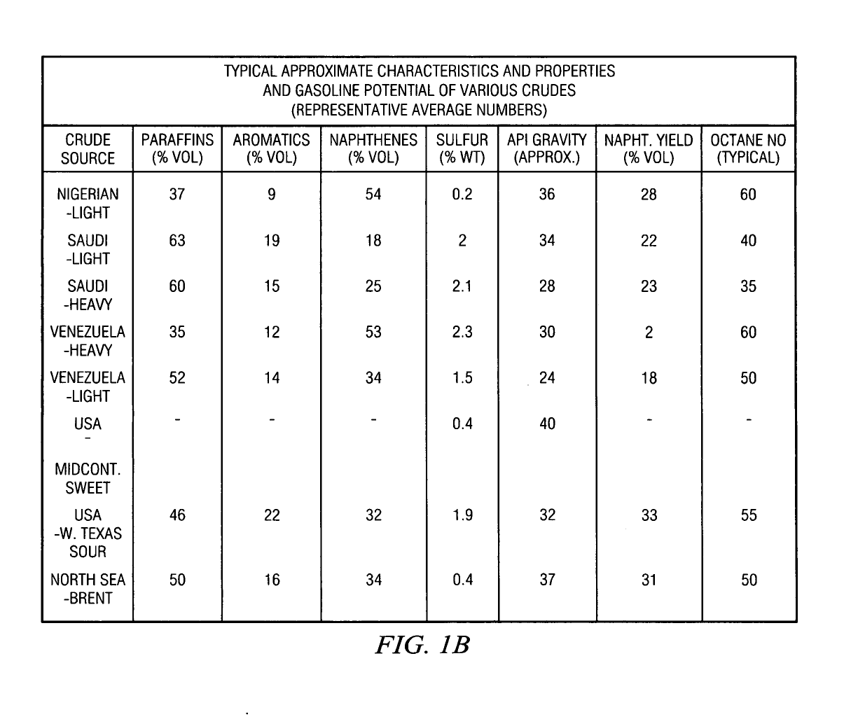

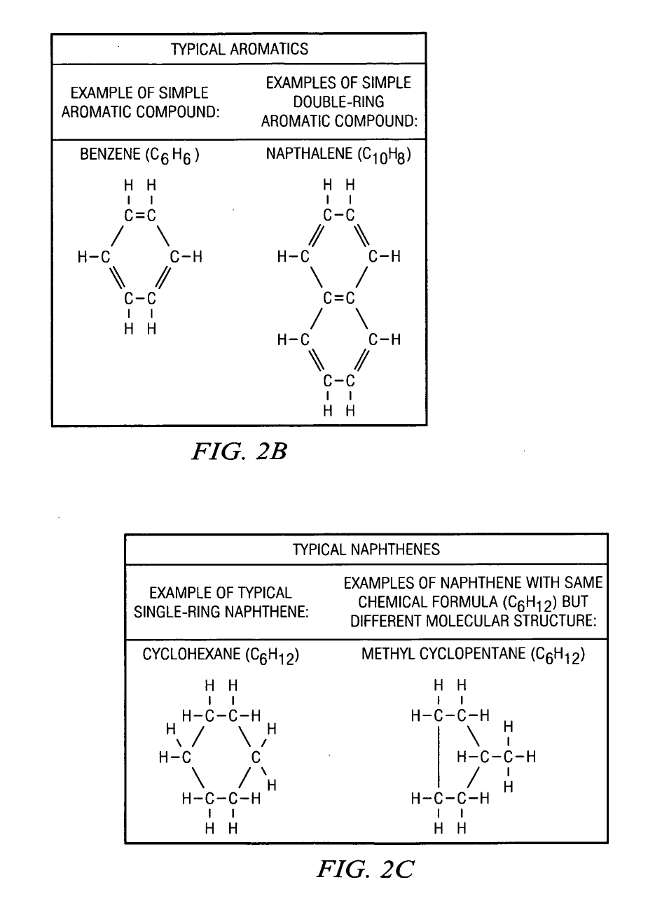

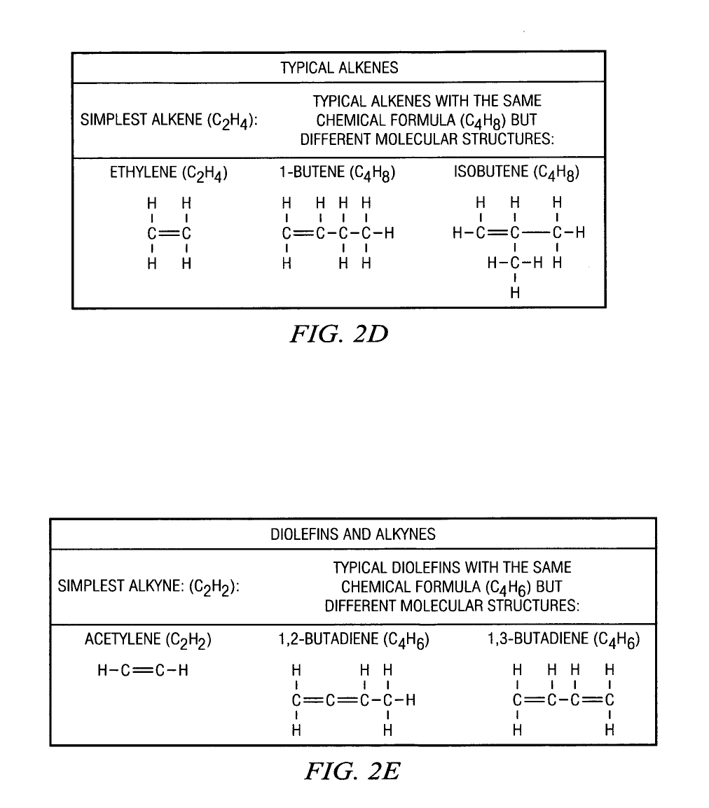

### DETAILED DESCRIPTION OF THE PREFERRED EMBODIMENT

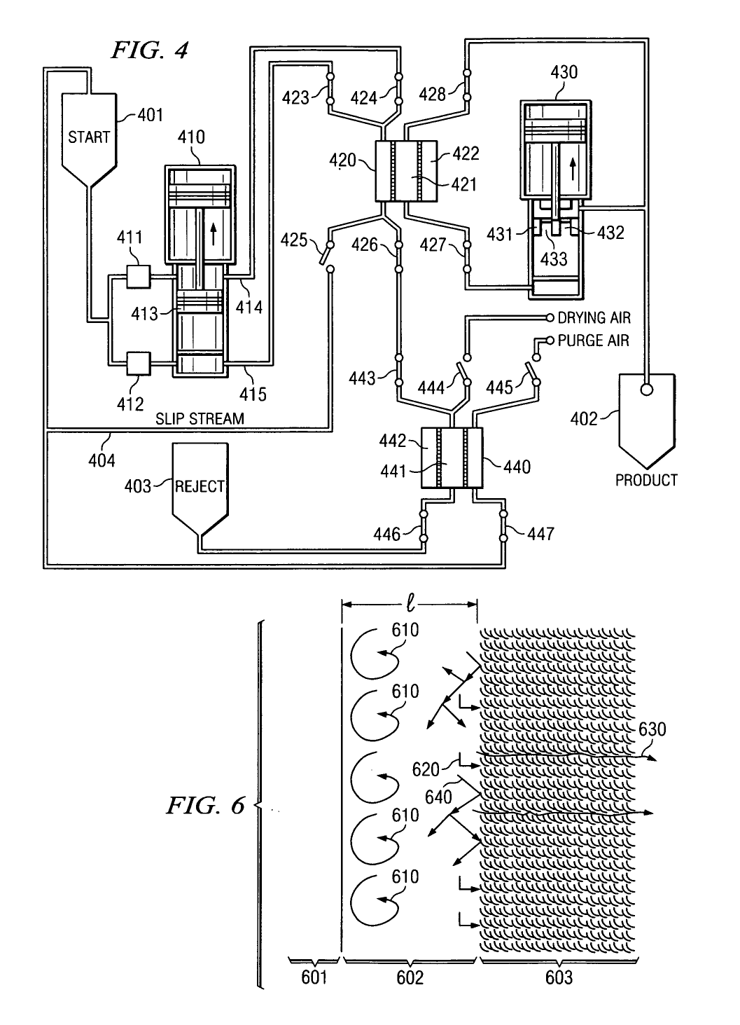

The use of filtration media to produce improvement in crude oil profiles is both novel and a significant improvement over existing traditional distillation systems. Referring now to FIG. 4, a schematic diagram illustrating the interaction of the functional components of the system is depicted in accordance with the present invention. A crude oil is placed in a storage tank 401. This crude oil may include sulfur compounds, contaminated water, industrial solvents, or any similar fluid or solid from which sub-fractions are to be separated.

The filtration process begins by drawing the crude oil from the starting tank 401 by means of a first pneumatic pump 410. The pneumatic pump 410 alternately draws the crude oil through two poppet valves 411, 412 via the upward and downward motion of the plunger 413, and alternately pumps the fluid through two out lines 414, 415. As the plunger 413 rises (as show in the present example), fluid is drawn through poppet valve 412. Simultaneously fluid is pumped out through line 414. When the plunger 413 reverses direction and pushes downward, valve 412 closes and the crude oil is drawn through poppet valve 411 and pumped out through line 415.

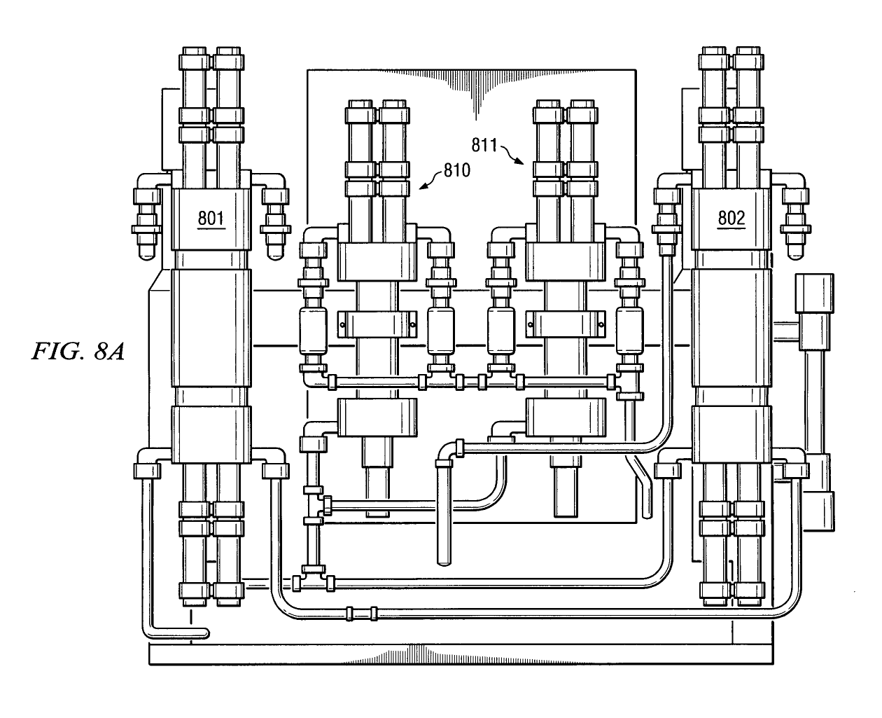

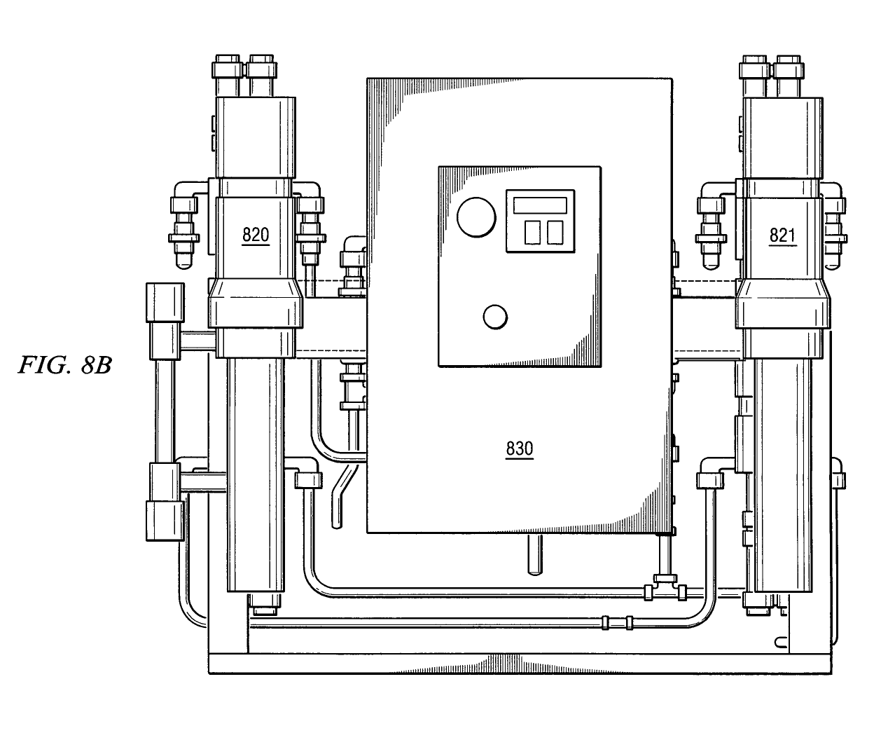

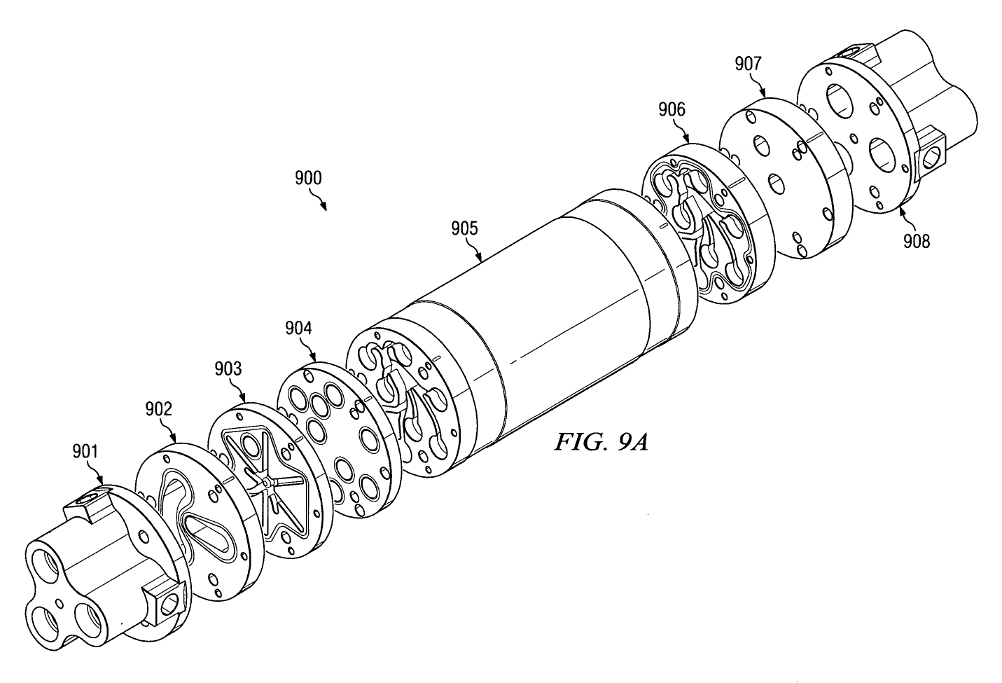

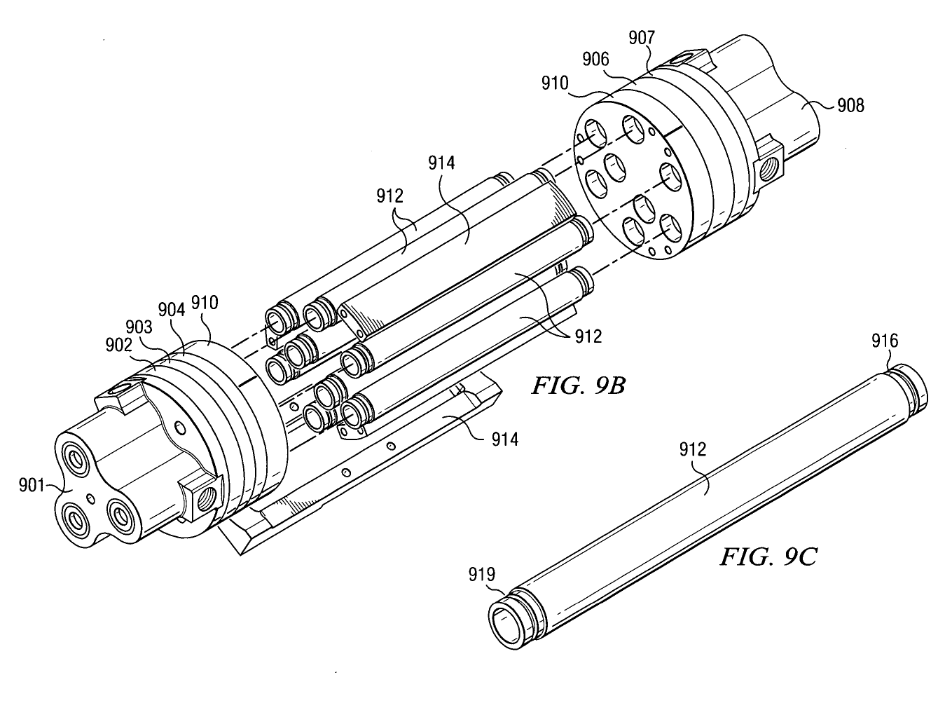

The crude oil moves through lines 414, 415 to a separator annulus 420. For the purposes of FIG. 4, a single separator annulus 420 with flux cartridge 421 inserted therein is shown for ease of illustration. In a preferred embodiment of the present invention, and as illustrated by FIG. 9b discussed later, eight such annuli are contained in a single separator filter pod. Seated within the annulus 420 is a filter media or flux cartridge 421. The flux cartridge 421 is the membrane that helps to separate the desired product from the crude oil. A space (referred to herein as fluid ring 422) exists between the inside surface of the annulus 420 and the outer surface of the flux cartridge 421. As crude oil is pumped through line 414, it passes through poppet valve 424 and is allowed to enter the annulus 420 via transition plates and into the fluid ring 422. When the crude oil is pumped through line 415, poppet valve 424 closes and the fluid passes through poppet valve 423 into the fluid ring 422.

Once in the fluid ring 422, the crude oil moves in a turbulent manner allowing the desired product to pass through the flux cartridge membrane and into the interior chamber of the flux cartridge 421, leaving behind contaminant particles and larger molecules as residue in the fluid ring 422, on the exterior of flux cartridge 421, and within the fissures of the flux cartridge 421. The pressure supplied by pump 410 pushes the filtered product out of the center of the flux cartridge 421 through a valve 427 and into a second pump, called a pneumatic ejector pump 430. Alternatively, the filtered fluid product may leave the flux cartridge 421 through an ejector bypass valve 428 and travel directly to a product collection tank 402. This ejector bypass is used when a single ejector pump 430 services multiple separator filter pods in alternative embodiments of the present invention.

During the filtration cycle described above, the ejector pump plunger 431 is drawn up (as shown in FIG. 4), which opens check valves 432, 433 that are built into the plunger's disc. In this position, the check valves 432, 433 allow the filtered product coming from the flux cartridge 421 to pass by the plunger 431 and out of the ejector 430 and into the product collection tank 402. This filtration cycle repeats for a pre-determined time period (e.g., 20-25 seconds). At the end of this pre-determined cycle period, the separator is backwashed and cleaned with a reverse flush (ejection cycle). Alternatively, a sensor assembly may be employed to measure the pressure drop across the flux cartridge or other appropriate location. When the pressure differential becomes excessive, the sensor assembly sends a corresponding signal to the central controller which initiates reverse flush operations (ejection cycle). Such sensor assemblies are known in the art and further description thereof is considered unnecessary.

The reverse flush operation or ejection cycle begins by stopping first pump 410 and shutting the poppet valves 423, 424 at the top of the separator filter pod in which the annulus 420 is contained. Next, the pneumatic ejector 430 is activated and plunger 431 is driven downward. This motion closes the check valves 432, 433 and stops the flow of filtered fluid past the plunger 431, allowing the plunger to exert pressure on the fluid inside the ejector. The fluid is pushed back through valve 427, through the flux cartridge 421 and into the fluid ring 422. The time period for this reverse ejection flush or ejection cycle is approximately 0.35 seconds and is carried out under higher pressure than the normal filtration cycle driven by pump 410. For example, the pressure exerted on the crude oil by pump 410 may be up to 150 psi (depending on the viscosity of the fluid involved). In contrast, the pressure exerted by the ejector 430 during the reverse flush may be up to 300 psi. This quick, high-pressure reverse burst removes contaminant particles and residue remaining within the fissures of the flux cartridge 421 and those on the outside surface of the flux cartridge 421 and re-homogenizes the particles and residue in the fluid ring 422 back into solution. Poppet valve 426 on the bottom of the annulus 420 is then opened to allow the pressurized contaminant particles and residue solution to flush out of the fluid ring 422 and into a concentrator annulus 440. The concentrator annulus 440, as its name suggests, concentrates the material flushed from the separator 420 by removing a significant portion of the flush fluid used during the ejection cycle. Unlike the separator filter pod, which may contain up to eight annuli in the preferred embodiment, the concentrator 440 contains only one annulus with a flux cartridge 441 seated therein. The flushed contaminant waste enters the concentrator annulus 440 through an open poppet valve 443 and into the interior chamber of the concentrator's flux cartridge 441. The desired effluent fluid passes through the membrane of the flux cartridge 441 and into the fluid ring 442, leaving the concentrated contaminant waste residue in the interior chamber of the flux cartridge 441. Poppet valve 447, which is located at the bottom of the concentrator annulus 440, allows the filtered fluid in the fluid ring 442 to return to the starting tank 401. Poppet valve 443, through which the waste fluid entered the concentrator 440, is closed and poppet valve 444 is opened to let drying air into the interior chamber of the concentrator flux cartridge 441. This drying air provides a mechanism to dewater the concentrated waste and drives additional flush fluid through the flux cartridge 441 membrane and through the return poppet valve 447.

The drying air poppet valve 444 and fluid return poppet valve 447 are then closed, and poppet valve 445, located on the top of the concentrator 440, is opened to allow in pressurized purging air. When the air pressure inside the concentrator 440 reaches a pre-determined or desired level (e.g. 110 psi), poppet valve 446 is opened which allows the waste residue inside the flux cartridge 441 to escape into a waste collection tank 403.

In alternative embodiments, a setting tank may be used in place of the concentrator to permit, for example, crude to be recycled back into the tank 401, or as enhanced product. It has been discovered that some of the material flushed from the separator 120 during the ejection cycle have components lighter than were provided from the initial crude from the crude oil storage tank 401. Without being bound by theory, it is believed that the forces imparted to the molecules within the fissures of the flux cartridge 121 may be responsible for this phenomenon.

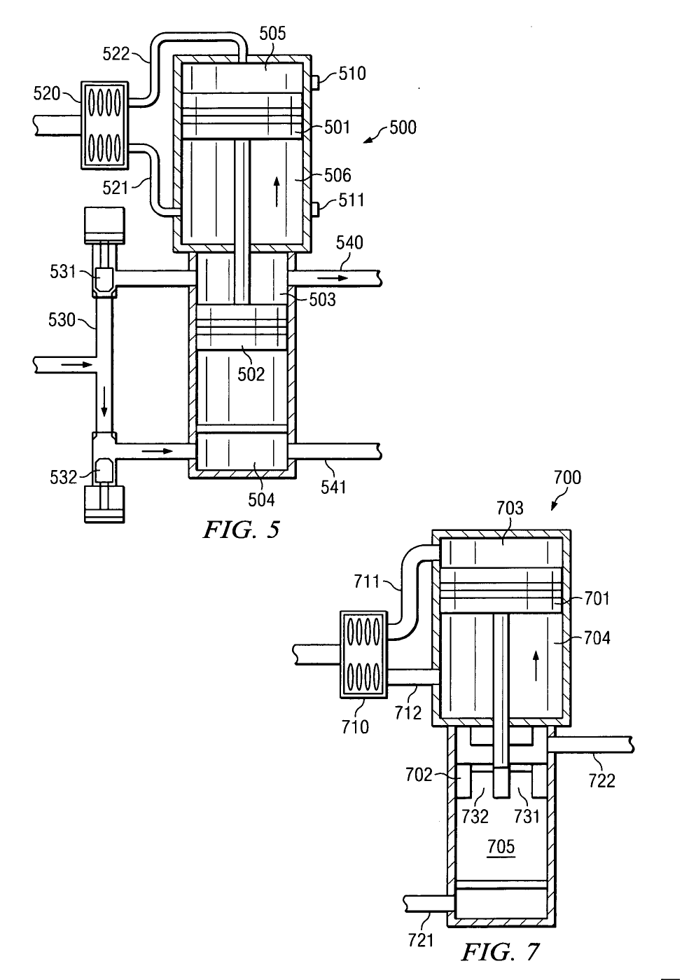

FIG. 5 is a schematic diagram illustrating the pneumatic pump 500 in more detail. This view better illustrates the mechanisms by which crude oil is pumped into the separator filter pod through alternating channels. The operation of the pneumatic pump 500 is controlled by monitoring the position of the top disc 501 as it cycles up and down. A magnetic strip with a positive pole (not shown) is placed inside the circumference of the upper disc 501. This magnetic strip is detected by two magnetic sensors 510, 511 positioned or attached along the side of the pump 500. As the upper disc reaches the end point of its movement (up or down), one of the sensors 510, 511 detects its position and relays this to a central controller, which coordinates the function of several solenoids that control the other components in the pump assembly. The sensors 510, 511 are adjustable up and down to facilitate calibration of the pump 500.

Referring to FIG. 5, the top disc 501 is moving upward due to pump air entering the lower half of the air chamber 506 through a hose 521. At the same time, exhaust air is being pushed out of the upper half of the air chamber 505 through another hose 522. In the lower portion of the pump 500, the upward movement of the lower disc 502 draws crude oil through a supply line 530 and an open poppet valve 532 and into the lower fluid chamber 504. Simultaneously, the lower disc 502 pushes fluid from the upper chamber 503 through an upper outflow line 540. Because the upper poppet valve 531 is closed, fluid is prevented from flowing from the upper chamber 503 back into the supply line 530 during the upstroke. Poppet valves 531, 532 open and closed at the desired intervals able to move fast to control the fluid flow at high pressure. In one embodiment, the top disc 501 is approximately six inches in diameter and operated to a maximum pressure of 110 psi at normal water. In one embodiment, the lower disc 502 is approximately 5 inches in diameter, producing a maximum operating pressure of 150 psi at normal water. These numbers are, however, provided for purposes of illustration and not limitation.

As the upper pump disc 501 reaches the top of its upward movement, its position is detected by the top magnetic sensor 510. The signal from this sensor 510 is relayed to a central controller, which instructs a control solenoid 520 to reverse the direction of air through hoses 521 and 522. Therefore, pump air will now move through hose 522 into the upper half of the air chamber 505, forcing the upper disc 501 downward, and the exhaust air will flow out through hose 521.

The central controller also instructs a control solenoid (not shown) to open poppet valve 531 and anther solenoid (not shown) to close poppet valve 532. Therefore, as the lower disc 502 moves downward, fluid is drawn into the upper chamber 503 through the upper poppet valve 531. Poppet valve 532, now in the closed position, prevents fluid backflow into the supply line 530 as fluid is pushed out of the lower chamber 504 and through lower outflow line 541. When the upper pump disc 501 reaches the bottom of its movement path, it is detected by lower magnetic sensor 511, which relays the disc's position to the central controller, and the pumping cycle repeats itself as described above. The pneumatic pump 500 as configured in the disclosed embodiment of the present invention is capable of producing flow rates between 40 to 60 gallons per minute. The pneumatic pump and ejector pump are powered by compressed air supplied via air circuit which is supplied by a compressed air source, preferably by a rotary air compressor as is known in the art. The pneumatic pump and pneumatic ejector pump may include carbon coated pump rods and piston components, which provide additional corrosion protection from contact with the untreated influent, effluent and waste materials involved in the process. Most of the other components are preferably constructed of stainless steel. The heads of the poppet valves are preferably made of marine brass because of its malleability, which allows the valves to maintain seal integrity over periods of sustained operation.

FIG. 6 is a cross-sectional view of the filter membrane 603 of the flux cartridge disposed within the filter annulus 607. The porous matrix of the filter membrane 603 is created by pressing or sintering metal powder, metal fibers, woven metal mesh or any combination of these at high pressure and then annealing it, using well-known metallurgical techniques as is known in the metallurgical art. Other methods of manufacturing filter membranes 603 will be apparent to those of skill in the art. This type of filter membrane provides both surface and depth filtration methods, in that although the pores at the surface of the filter membrane may be larger than the filter specification, the flow path through the filter is tortuous and contaminant particles are intercepted by the metal media. Sintered metal media typically exhibit a high porosity, and therefore high flow rate/low pressure drop, with excellent contaminant particle retention. The present invention uses a lower membrane thickness than those typically found in the prior art (e.g. ⅛ inch versus 3/16 inch), which produces a much higher flow rate through the filter membrane 603. Utilization of these lower thicknesses are possible, in part, due to controlled fluid turbulence which is present in the fluid ring 602 during operation of the invention disclosed herein. In the disclosed embodiment, the fluid ring length (l) is preferred to be ⅛ inches when used in conjunction with a flux cartridge diameter of ⅜ inch. These dimensions have been found to optimize the volume of reverse flush fluid required to clean the separator annuli and minimizing the amount of reverse flush fluid required to clean the separator annuli. To obtain effective filtration and reverse flush efficiencies utilizing the apparatus embodiment described herein, the desired ratio of fluid ring length (l) to the diameter of flux cartridge utilized is typically 1 to 3, respectively, when using a ⅜ inch diameter flux cartridge.

The turbulent flow of the crude oil in the fluid ring 602 is represented by curved arrow 610. This turbulent flow is created and controlled by the pressure differential and the rhythmic pumping action of the pneumatic pump (pump 410 in FIG. 4) and actuation of the poppet valves within the valve head assemblies of the separator (i.e. 901, 908 in FIG. 9). As the poppet valves (i.e. 423, 424 in FIG. 4) open and close with the alternating fluid streams coming from the pump, a temporary drop in pressure in the fluid ring 602 is caused when the poppets switch position (open or closed), creating a slight suction action after each infusion of fluid. This suction action causes the fluid to pulse up and down within the fluid ring 602, resulting in the turbulence represented by arrow 610. This turbulence is magnified or increased by the speed of the fluid moving through the relatively small space in the fluid ring.

When fluid flows smoothly without turbulence, this type of fluid flow is called laminar. Typically, when a fluid is flowing this way it flows in straight lines at a constant velocity. If the fluid hits a smooth surface, a circle of laminar flow results until the flow slows and becomes turbulent. At faster velocities, the inertia of the fluid overcomes fluid frictional forces and turbulent flow results producing eddies and whorls (vortices). The present invention utilizes turbulent fluid dynamics to manipulate molecular kinetics such that only the desired, smaller molecules will pass through the membrane matrix 603, shown by arrow 630. In one embodiment, to pass through the fissures of the flux cartridge membrane 603, a molecule in the fluid ring 602 has to enter interstices or fissures at almost a 90° angle or perpendicular to the surface of the membrane 603 when the molecule contacts the membrane as represented by arrow 620. Due to the constant fluid turbulence, only the lighter molecules are able to make this turn fast enough to pass through the membrane 603 and enter the interior chamber of the flux cartridge. Heavier molecules (e.g., longchain and complex hydrocarbons, iron) cannot turn fast enough to reach the appropriate entry vector or angle when they contact the membrane 603. As shown in FIG. 6, when heavier molecules hit the uneven surface of the membrane surface, rather than pass through, they careen off and strike similarly sized molecules, causing them to scatter as well and increasing the kinetic energy present in the fluid ring between the annulus and flux cartridge. This kinetic pattern is illustrated by arrow 640. In the absence of fluid turbulence or when laminar fluid flow conditions exist, the heavier molecules in the fluid stream would lose a majority of their kinetic energy and be able to enter the membrane at the appropriate vector. Thus, fluid turbulence is necessary to keep the heavier molecules bouncing off the surface of membrane 603. As fluid turbulence increases, the smaller a molecule has to be in order to turn and make the appropriate entry vector to pass through the membrane 603. Therefore, the filtration of smaller molecules can be accomplished by using a flux cartridge with a less porous membrane matrix and/or increasing the fluid turbulence within the separator fluid ring 602.

The present invention also provides a novel method of achieving the filtration of increasing smaller particle and molecule sizes by membrane emulation, since the filtering effects of a smaller membrane matrix can be achieved without actually changing the porosity of the flux cartridge interstices. Referring back to FIG. 4, a slipstream poppet valve 425 controls the flow of fluid from the separator fluid ring 422 to a slipstream fluid hose or path 404 that feeds back to the start tank 401. During membrane emulation, this slipstream poppet valve 425 is opened while the first pneumatic pump 410 is pumping pressurized crude oil into the separator fluid ring 422, which allows the crude oil to move through the fluid ring 422 at a faster velocity due to the increased pressure differential. As explained above, as fluid velocity increases so does fluid turbulence. With the membrane emulation technique, the present invention is able to turn, for example, a five-micron filter into the functional equivalent of a one-micron filter by increasing the turbulent flow of fluid in the separator fluid ring 422 due to the large pressure differential created by the slipstream path 404.

Returning to FIG. 6, another chemical effect produced by the filter matrix is cavitation of the filtered fluid as it passes through the membrane 603. Cavitation (the formation of bubbles) is produced when the static pressure in a fluid falls below the temperature-related vapor pressure. A forceful condensation (implosion) of the bubbles occurs when the fluid reaches a region of higher pressure. In the present invention, as the filtered fluid passes through the interstices of membrane 603 cavitation results and gas bubbles are produced. When these gas bubbles reach the inner fissures of the flux cartridge (arrow 630) they begin to rapidly implode. During this implosion process, like molecules come together (flocculation) and form precipitates, which allows targeted separation of dissolved material from the filtered fluid. Another chemical effect produced by the filter matrix is the break up of emulsions in the filtered fluid. As the filter fluid is pushed through the flux cartridge membrane 603 under pressure emulsions in the fluid are broken. By using different size filter matrices and fluid velocities, the present invention is capable of separating particles from 300 microns down to 58 Angstroms.

FIG. 7 is a schematic view illustrating the pneumatic ejector pump 700 in more detail. The cycling action of the pneumatic ejector pump 700 is controlled by a solenoid 710 that alternates the pump air between two hoses 711, 712. However, unlike the first pneumatic pump, the cycling of the pneumatic ejector pump 700 is not monitored by magnetic sensors. As shown in FIG. 7, the upper disc 701 is pushed up by air coming into the bottom half of the air chamber 704 through the lower hose 712. At the same time, exhaust air is pushed out of the upper air chamber 703 through upper hose 711. As the lower disc 702 is pulled up, check valves 731, 732 built into the seal around the disc are pulled open by friction. Once the ejector 700 is in this upper position, the pump air through the solenoid 710 is cut off, and the ejector is held in this position for the duration of the filtration cycle. As filter fluid product leaves the separator filter pod, it enters the pneumatic ejector fluid chamber 705 through line 721. Because the check valves 731, 732 are held open in this upstroke position, the fluid product is able to pass by the lower plunger disc 702 and flow out to a collection tank through line 722.

When the reverse flush cycle is executed, the solenoid 710 directs pump air through the upper hose 711 into the upper half of the air chamber 703, which drives the upper disc 701 downward, forcing exhaust air out of the lower half of the air chamber 704 through the lower hose 712. As the lower disc is pushed down, friction from the seal closes the check valves 731, 732, preventing fluid from passing through. As a result of the closed check valves 731, 732 fluid in the chamber 705 is forced back out through line 721 and back into the flux cartridges positioned within the separator as previously shown herein.

During the reverse flush, the time required for the pneumatic ejector 700 to begin exerting pressure is less than approximately 0.10 seconds and the time required to complete the downward stroke is approximately 0.35 seconds. In one embodiment, the top disc 701 is approximately six inches in diameter and operated to a maximum pressure of 110 psi at normal water. In one embodiment, the lower disc 702 is approximately 4 inches in diameter, producing a maximum operating pressure of 250 psi at normal water. The combination of higher fluid pressure and short stroke time make the reverse flush operation a sudden, shock load to the separator, which aids in the complete and expeditious removal of material residue from the outer surface of each flux cartridge positioned within the separator annuli. In the disclosed embodiment and as an example, the reverse flush operation cycle utilizes between 1200 and 2000 milliliters of rinse fluid to clean one separator pod with eight annuluses therein and the reverse flush cycle is completed within 0.2 to 0.7 seconds depending on the physical characteristics of the fluids being treated such as particle size and viscosity, among others.

FIG. 8A is a rear view pictorial diagram of a preferred embodiment of the system apparatus. In this view one can see the separator filter pods 801, 802 that contain the separator filtration annuli and flux cartridges disposed therein, as well as the concentrators 810, 811. FIG. 8B is a front view pictorial diagram of the apparatus, which depicts the pneumatic pumps 820, 821, various fluid connection lines and a control panel 830. First pneumatic pump 820 is the positive pressure pump that pumps the crude oil into the filter annuli. Pneumatic ejector pump 821 provides the reverse flush fluid and pressure for backwashing the separator pod(s) and transporting the waste residue into the concentrators 810, 811. In one embodiment, the first pneumatic pump 820 and pneumatic ejector pump 821 are positioned vertically to facilitate even surface wear during operations. In an alternative embodiment, the pneumatic pump 820 is positioned horizontally. The control panel 830 includes data entry and control inputs and houses the central controller electronics and circuitry required to operate the invention disclosed herein and allow operator control of the performance of the desired processes disclosed herein. The control panel 830 may also house electronic equipment enabling the remote control of the unit via wired or wireless communication means as is known in the art. The control panel 830 is designed to be capable of being internally pressurized, allowing the invention to be used in hostile environments containing volatile, explosive or corrosive conditions and protecting the enclosed circuitry therein from damage. The storage tanks for the various liquids and products, as well as the connection hoses for the controlling solenoids are not shown in FIGS. 8A and 8B for ease of illustration.

FIG. 9A is an exploded, perspective view of a separator filter pod. The separator filter pod 900 comprises a main body 905 that contains eight filter annuli disposed therein. A flux cartridge is seated within each annulus as disclosed herein. At either end of the separator filter pod 900 are valve heads 901, 908 which contain poppet valves which control the inflow and outflow of fluid to and from the separator filter pod 900. Between the top valve head 901 and the main body 905 are three transition plates 902-904, which include machined fluid flow pathways for facilitating the distribution of inflow and outflow fluid to and from the separator main body 905. Two transition plates 906, 907 are placed between the main body 905 and the bottom valve head 908 which include machined fluid flow pathways for facilitating the distribution of fluid flowing into and out of the separator main body 905. The general external dimensions of the separator pod 900, including assembled transition plates and valve heads, is roughly 60 inches long with a diameter of 7 to 8 inches. The separator components, including the valve heads, transition plates and main body may be constructed from HASTELLOY, 316L stainless steel, or other metal alloys sufficient to provide corrosion protection to the components of the invention and containment of the fluids passing through same. The preferred embodiment of the present invention uses components fabricated from stainless steel. The separator and concentrator components disclosed herein may be integrated with VITON or CALREZ seals for leak prevention and containment under pressure. VITON seals are preferably used with stainless steel embodiments, while CALREZ seals would be preferable for use with embodiments constructed out of HASTELLOY.

FIG. 9B depicts an alternative embodiment of the separator filter pod discussed above. In this embodiment, eight media housing tubes 912 are utilized as the annuli into which the flux cartridges are inserted as previously discussed herein. Such a separator filter may also be referred to herein as a “Q-Pod”. Valve heads 901, 908 are located at the end of the unit each of which contain poppet valves which control the inflow and outflow of fluid to and from the separator filter pod 900. Between the top valve head 901 and the media housing tubes 912 are three transition plates 902-904, which include machined fluid flow pathways for facilitating the distribution of inflow and outflow fluid to and from the separator main body 905. The media housing plates 910 provides a secure connection point for the media housing tubes 912 and facilitates the distribution of inflow/outflow fluid to the media housing tubes 912 via transition plates 902-904. The media housing lower plate 910 provides a secure connection point for the media housing tubes 912 and facilitates the distribution of inflow/outflow fluid to the media housing tubes 912 via transition plates 906, 907. Transition plates 906, 907 are placed between the media housing plate 910 and the bottom valve head 908 which include machined fluid flow pathways for facilitating the distribution of fluid flowing into and out of the media housing tubes 912. Three rib plates 914 are positioned and detachably secured to the upper and lower media housing plates 910 to provide support for the separator filter pod assembly as shown. In this embodiment, the volume of fabrication material required is conserved and the weight of the separator filter pod and the overall unit is proportionately decreased. The separator filter pod components, including the valve heads, transition plates, rib plates and media housing tubes may be constructed from HASTELLOY, 316L stainless steel, or other metal alloys sufficient to provide corrosion protection to the components of the invention and containment of the fluids passing through same. The preferred embodiment of the present invention uses components fabricated from stainless steel. The separator and concentrator components disclosed herein may be integrated with VITON or CALREZ seals for leak prevention and containment under pressure. VITON seals are preferably used with stainless steel embodiments, while CALREZ seals would be preferable for use with embodiments constructed out of HASTELLOY.

FIG. 9C is a perspective close up view of a typical media housing tube 912. The media housing tube 912 is machined so as to include preformed, circumferential grooves 916 at both ends of the media housing tube 912 for retention of O-ring type gaskets that seal the connection of the media housing tube 912 and media housing plates 910 as shown in FIG. 9B. As previously discussed, a single media housing tube 912 is constructed of appropriate dimensional size so as to allow insertion and removal of the flux cartridge from the media housing tube 912.

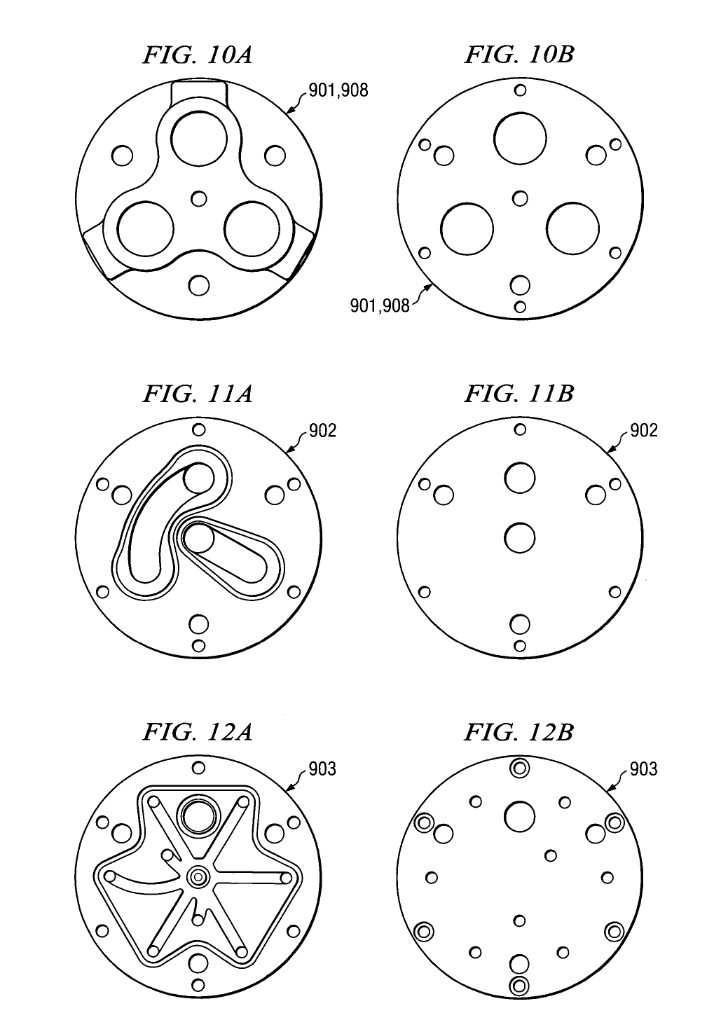

FIG. 10A is an end on view of the top of the valve heads 901 and 908. FIG. 10B is an end on view of the bottom of the valve heads 901, 908.

FIG. 11A is an end on view of the top of the first transition plate 902. FIG. 11B is an end on view of the bottom of the transition plate 902.

FIG. 12A is an end on view of the top of the second transition plate 903. FIG. 12B is an end on view of the bottom of the transition plate 903.

FIG. 13A is an end on view of the top of the third transition plate 904. FIG. 13B is an end on view of the bottom of the transition plate 904.

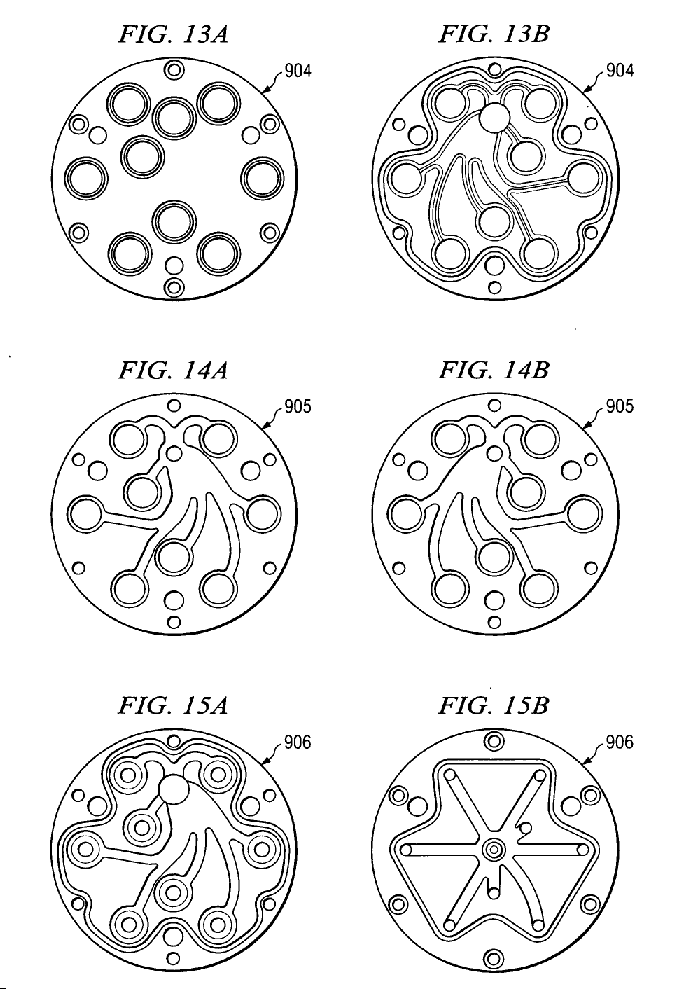

FIG. 14A is an end on view of the top of the main body 905. FIG. 14B is an end on view of the bottom of the main body 905.

FIG. 15A is an end on view of the top of the fourth transition plate 906. FIG. 15B is an end on view of the bottom of the transition plate 906.

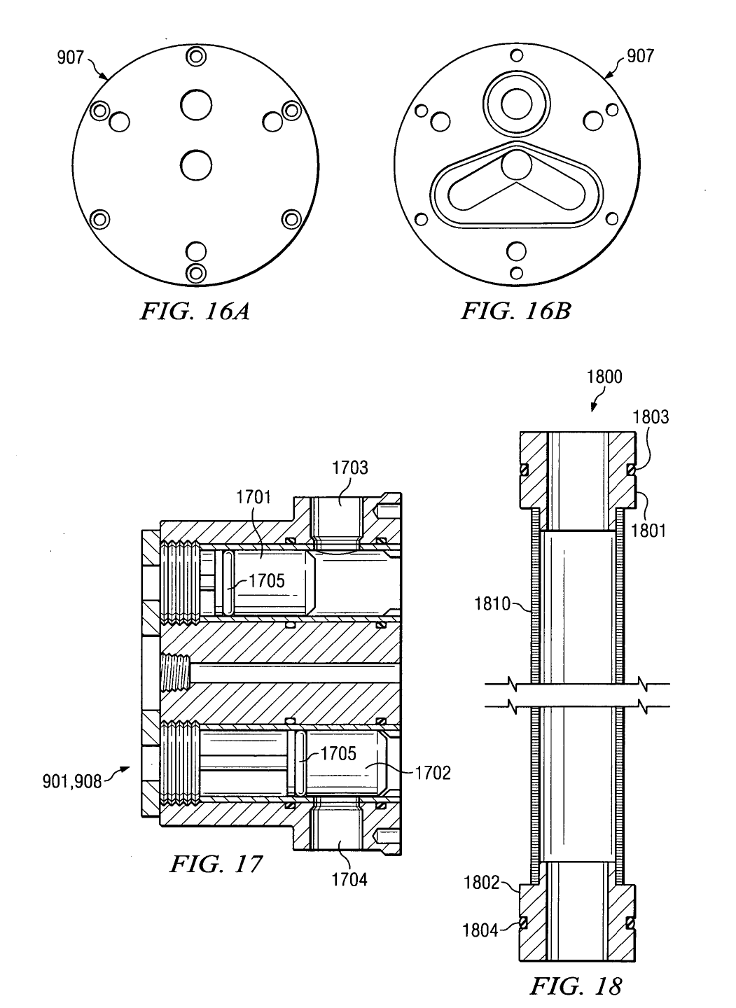

FIG. 16A is an end on view of the top of the fifth transition plate 907. FIG. 16B is an end on view of the bottom of the transition plate 907.

The depicted geometric patterns consisting of machined cuts, grooves and holes on and through the transition plates and main body 902-907 are fluid flow channels. These particular geometric patterns are used to ensure even fluid flow to and from the eight annuli in the separator main body 905. The transition plates may be secured to the main body of the separator and/or concentrator with internal threaded fastening means and external threaded bolt means, which provide easy access and removal of the transition plates for facilitating flux cartridge removal and replacement from the annuli of the separator filter pod and concentrator annulus.

FIG. 17 is a cross section schematic diagram of the poppet valve heads 901, 908. These poppet valves 1701, 1702 are similar to those illustrated in FIG. 5 (e.g. 531, 532) but are smaller in dimensional size. The third poppet valve cannot be seen in this view of FIG. 17, as it is disposed on the opposite side. The poppet valves in FIG. 17 depict the alternating positions of the valves, which allow the flow of fluid flow into and out of the valve heads and to and from the separator and/or concentrator via the transition plates shown in FIGS. 10A-16B.

Relating FIG. 17 to the example in FIG. 4, when fluid is being pumped through the upper line 414, valve 424 is open and valve 423 is closed. This can be seen in greater detail in FIG. 17, with poppet valve 1701 corresponding to valve 424, and poppet valve 1702 corresponding to valve 423. When poppet piston 1701 is pulled back into the open position, fluid can enter the separator filter pod through opening 1703. With poppet piston is extended 1702, fluid is prevented from entering through opening 1704. All of the poppet pistons or valves utilized in the invention disclosed herein may also include a circumferential indentation in the head of the piston to retain an O-ring seal 1705 (preferably VITON), as shown in FIG. 17, to prevent fluid leakage or blowby during operations.

FIG. 18 is a side pictorial view of a flux cartridge. In the preferred embodiment, the flux cartridge 1800 is essentially a metallic narrow tube annealed to form a porous media of desired size (e.g. 10 micron, 5 micron, etc.), although other filtration media could be adapted for the desired purpose as is known in the art. The body of the flux cartridge tube 1810 constitutes the filter membrane described herein. Welded to either end of the flux cartridge body 1810 are seating heads 1801, 1802, with a circumferential indentation for retaining an O-ring seal (preferably VITON seals) 1803, 1804, respectively. Flux cartridges are inserted into cylindrical holes (annuli) that run the length of the separator filter pod main body. The openings of these cylindrical holes are shown in FIGS. 9A, 14A and 14B. Each one of the cylindrical holes constitutes a fluid inlet or outlet to an annulus within the separator. The inner portion of the seating heads on the flux cartridges fit into the annulus openings within the separator filter pod main body. The outer portion of the seating heads fit into matching holes in the proximate transition plates 904 and 906. The matching holes in the transition plates 904, 906 are shown in FIGS. 13B and 15A, respectively.

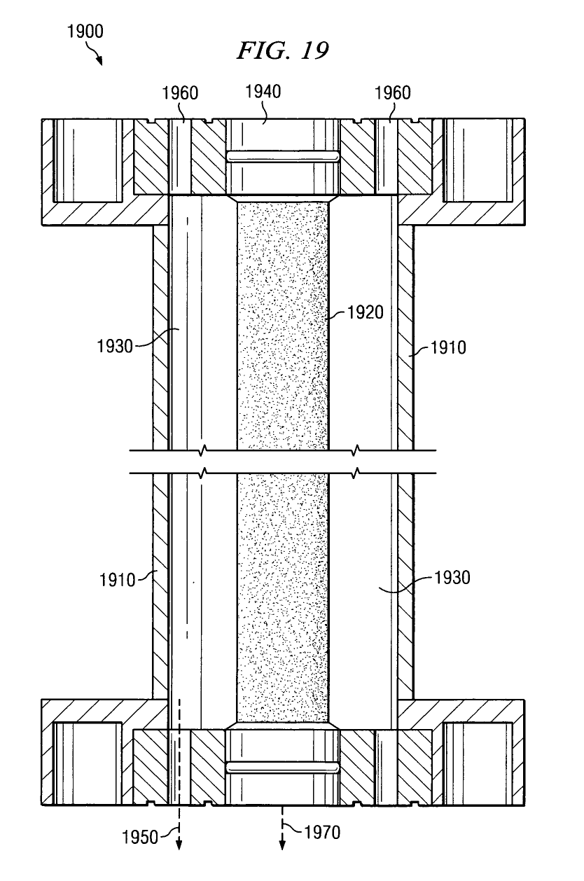

FIG. 19 is a cross section schematic diagram illustrating a concentrator in more detail. In contrast to the separator filter pod (which contains eight annuli), the concentrator 1900 contains only one annulus 1910 with a single flux cartridge 1920. The fluid ring 1930 of the concentrator 1900 is considerably larger than that of the separator filter pod annuli, and the flux cartridge 1920 is also larger than the separator filter pod flux cartridges. This larger size (volume capacity) is necessary since the single annulus 1910 in the concentrator 1900 must process waste fluid from all eight annuli in the separator filter pod. The concentrator includes appropriate transition plates and valve heads as described herein which operate to control the passage of contaminate backwash fluid, drying air, and purge air as discussed herein.

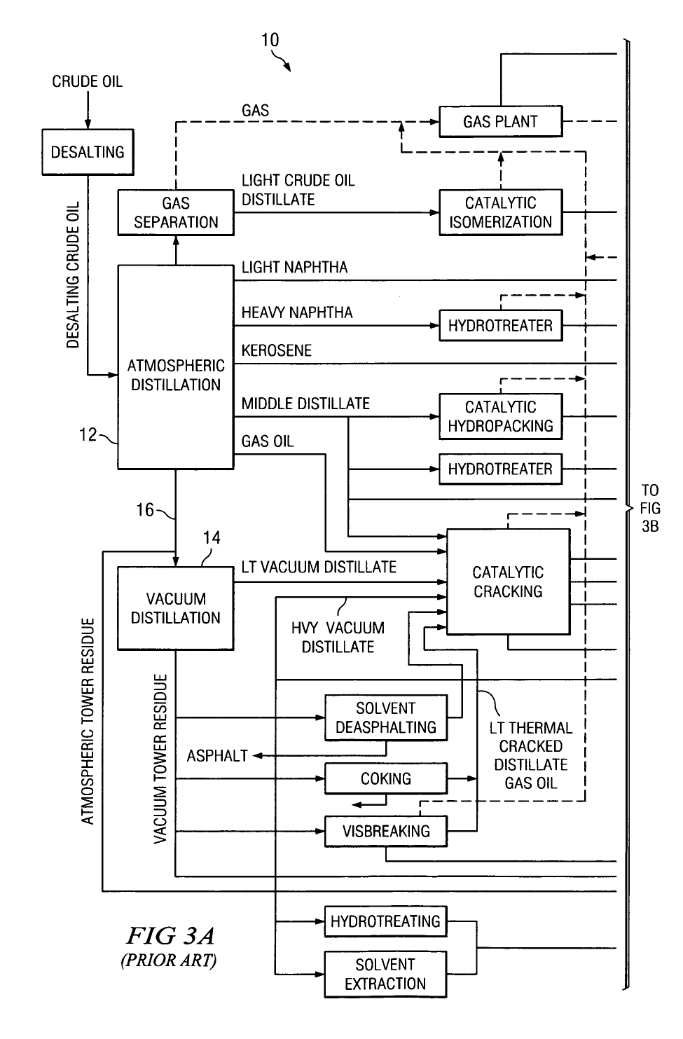

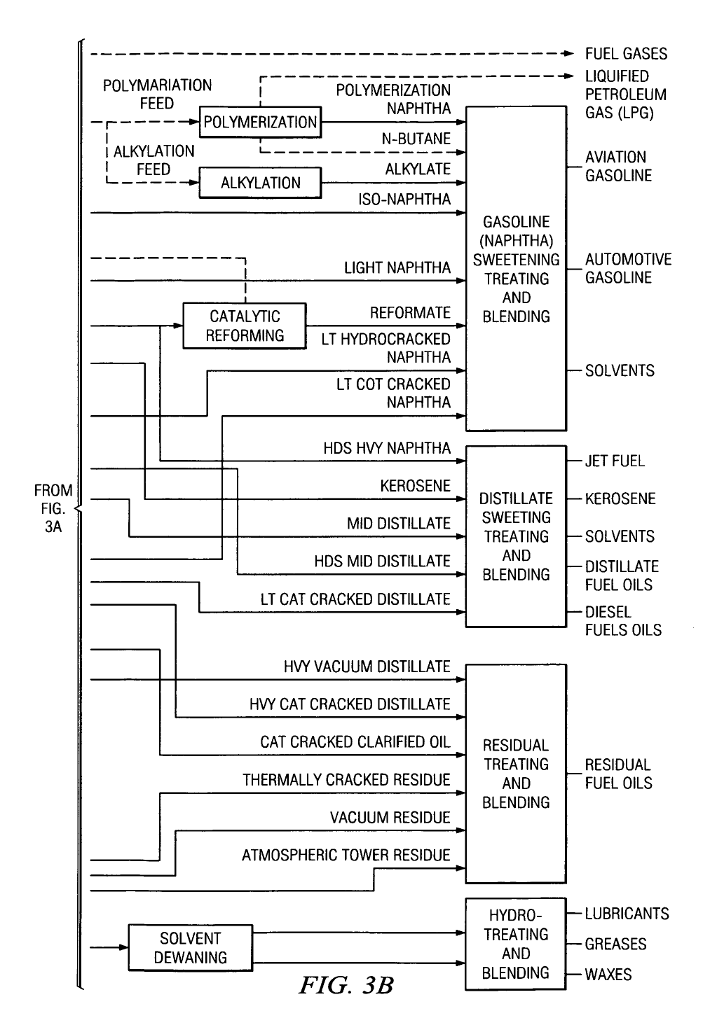

As described above, a concentrator can receive and filter the backwash fluid received from the separator fluid ring during the ejection cycle using the same filtration methodologies discussed herein, except the flow of fluid through the concentrator is in the opposite flow direction in comparison to the separator filter pod. Backwash fluid from the separator filter pod flows into the center into the interior of the concentrator flux cartridge 1920 as indicated by numeral 1940. The desired fluid then filters through the membrane of the flux cartridge 1920 into the fluid ring 1930, similar to the process described above in relation to FIG. 3. From there, the filtered effluent fluid flows out of the concentrator 1900 through the fluid return line back to the start tank, as indicated by arrow 1950. After backwash fluid inflow from the separator filter pod is stopped, drying air enters the interior of the concentrator flux cartridge 1920 through the same path indicated by numeral 1940. This drying air pushes additional fluid through the filter membrane of the flux cartridge 1920 and further concentrates the waste residue collected on and within the interstices of the concentrator flux cartridge 1920.

After the drying air flow is stopped by closing the appropriate valve(s), a burst of purge air enters the fluid ring 1930 through the port as indicated by numeral 1960. This burst of purge air is similar to the reverse ejection flush used with separator filter pods. Its purpose is to remove reside adhering to the surface and interstices of the flux cartridge 1920, but in this case, the reside must be removed from the inside surface of the flux cartridge 1920 rather than the outer surface which is exposed to the fluid ring 1930. The purge may also be performed with any other preferred fluid in place of air. The contaminant waste removed by the purge is flushed out of the flux cartridge 1920 as indicated by arrow 1970 into a collection tank as previously discussed. In one embodiment, the general external dimensions of the concentrator 1900, including assembled transition plates and valve heads attached, is roughly 40 inches long with a diameter of 7 to 8 inches. As with all exact dimensions and ranges used within this specification, these ranges and numbers are given for purposes of illustration and not limitation.

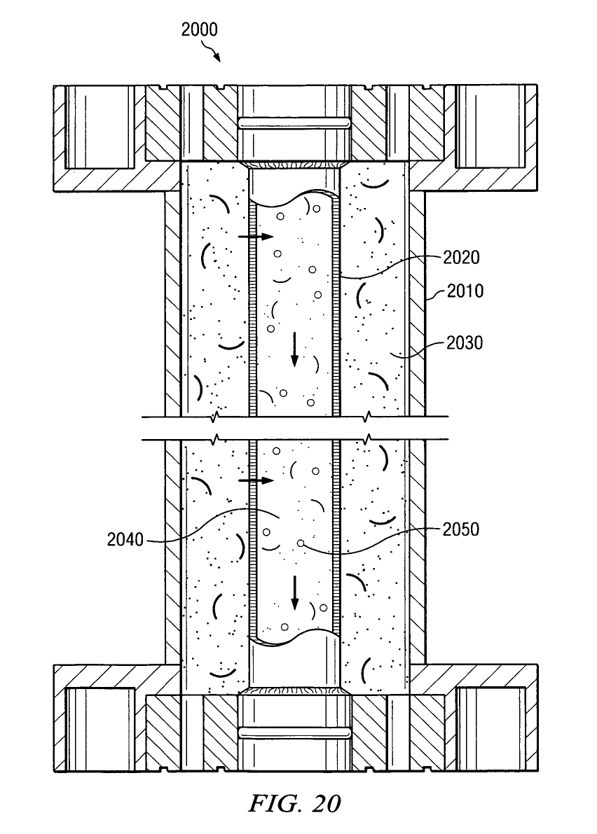

FIG. 20 provides a cross-sectional view of the filter membrane 2020 of the flux cartridge in a separator. Crude oil is forced through the filtration media under pressure. In this highly simplified illustration, longer hydrocarbons 2030 are forced though the media and are reduced to lighter, more valuable hydrocarbons 2040. The pressure drop experienced by the crude oil creates cavitation bubbles 2050.

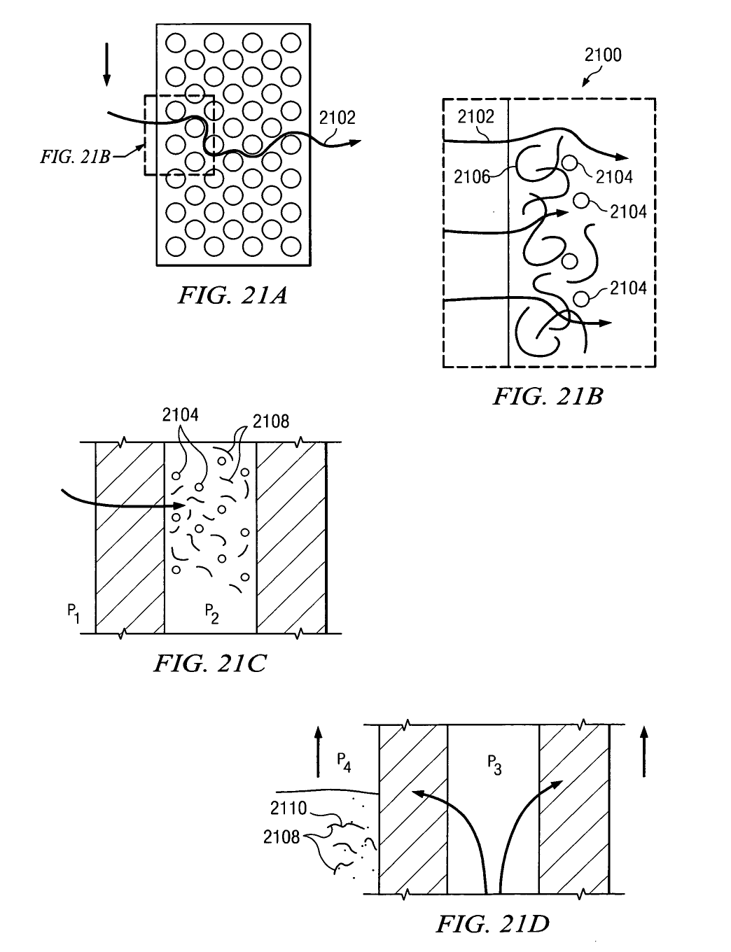

FIG. 21a is a cross-sectional view of the filter membrane of the flux cartridge inside the annulus of a separator. The filter membrane can be a sintered metal media which is known to exhibit a high porosity and high flow rate and low pressure drop. The arrow illustrates an example of a tortuous path 2102 taken through the filter membrane as a result of the rhythmic pumping action of the pneumatic pump during the filtration cycle in accordance with one embodiment of the present invention. FIG. 21B is a blown-up sectional view of a portion of the filter membrane depicted in FIG. 21A. Without being bound by theory, it is believed that the turbulent forces caused by the filtration and ejection cycle of the present invention can create pulsating energy waves that causes hydrodynamic cavitation and results both physical and chemical changes to the relatively heavier hydrocarbons 2106. Cavitation is the formation, expansion, and implosion of microscopic gas bubbles 2104 in liquid. The shockwaves produced by the cavitation may accelerate particles 2106 to high velocities and increase inter-particle collisions. Additionally, localized spots of high temperature and high pressure may be produced during the final phase of implosion. The presence of these localized high temperature and high pressure gradients in addition to the kinetic energy formed by the shockwaves may encourage the decomposition or cracking of the hydrocarbons by both mechanical and thermal means. For example, the mechanical energy imparted on large molecules, such as asphaltenes in the filter media, may be analogous to pushing, extruding, or forcing a large circular molecule through a smaller pipe and may force the intra-molecular bonds to be overcome. The cavitation may occur in the inner fissures or interstices of the flux membrane and/or the interior of the flux cartridge in the vicinity of the flux cartridge membrane during the filtration cycle or in the vicinity of the fluid ring during the ejection cycle.

FIG. 21C is a partial cross-sectional view depicting the general direction of flow in the flux cartridge that occurs during a filtration cycle. As used herein, the filtration cycle is defined as when P1 is greater than P2. In one embodiment, the pressure differential between P1 and P2 is between about 10 and 50 psi. During the filtration cycle the hydrocarbons are forced through the filter membrane from the annulus into the interior chamber of the flux cartridge resulting in cracked hydrocarbons 2108. Also, without being bound to theory, it is believed that some of the microscopic gas bubbles 2104 may also be present outside the filter membrane and in the interior chamber of the flux cartridge. In one embodiment, the filter membrane has a length or thickness of between about ¼ and ⅜ inches.

FIG. 21D is a partial cross-sectional view depicting the general direction of flow in the flux cartridge that occurs during an ejection cycle. As used herein, the ejection cycle is defined as when P3 is greater than P4. In one embodiment, the pressure differential between P3 and P4 is between about 150 and 300 psi. As depicted in the Figure, during the filtration cycle the hydrocarbons are forced through the filter membrane from the annulus into the interior chamber of the flux cartridge resulting in cracked hydrocarbons 2108. Interestingly, when backpressure is applied during the ejection cycle further cracking of crude occurs and many of the cracked hydrocarbons 2108 from the interior chamber of the flux cartridge or within the filter membrane can be cracked even further. Surprisingly, preliminary tests have indicated that more cracking of the crude can occur during the ejection cycle than in the filtration cycle. This may be due to the vigorous cavitation that occurs in the filter media fissures and its vicinity by rapid changes between the filtration cycle and ejection cycle. Hence, the timing of the filtration and ejection cycles can be optimized based on the feed stream composition. Additionally, some of the undesirable compounds including sulfur components, such as sulphates and sulfides, may combine 2110 through flocculation or agglomeration on the outer flux cartridge.

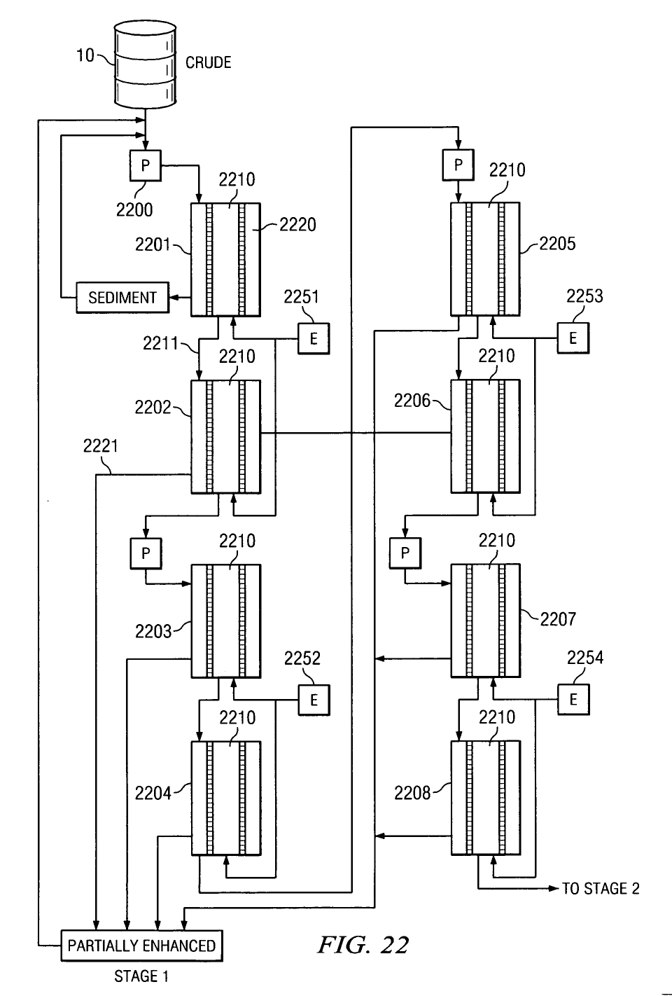

FIG. 22 is a schematic diagram depicting one stage of the inventive process in accordance with one embodiment of the present invention. Unprocessed crude 10 is routed by a pump 2200 to a first filter pod 2201. Although the first filter pod 2201 is depicted as a single vessel in FIG. 22, it should be noted that there can be a plurality of first filter pods 2201 operating in parallel.

Seated within each filter pod 2201-2208 is a filter media or flux cartridge 2210. FIGS. 9A-9B are two possible embodiments of the filter pods. Referring back to FIG. 22, the flux cartridge is the membrane that facilitates molecular breakdown of the crude 10. A space (referred to herein as the fluid ring 2220) exists between the inside surface of the first annulus device 2201 and the outer surface of the flux cartridge 2210. As crude is pumped into the first filter pod 2201 it enters the fluid ring 2220. Once in the fluid ring 2220, the crude moves in a turbulent manner through the flux cartridge membrane 2210. In one embodiment, the first filter pod 1201 has flux cartridge membrane 2210 comprising a filter media of about 40 microns.

Without being bound by theory, it is believed that cavitation bubbles having localized areas of very high temperatures and pressures may be created thereby causing several physical and chemical phenomena, including thermal cracking of carbon-carbon bonds as the crude 10 moves through the flux cartridge membrane 2210. Heavy hydrocarbons and residues are thereby cracked into smaller lowering boiling molecules having a higher API gravity. Once the relatively smaller hydrocarbons pass through the flux cartridge membrane into the flux cartridge 2210 interior, the effluent can be routed to a second filter pod 2202. It should also be pointed out that lighter hydrocarbons formed can volatilize and special provisions may be needed to efficiently capture these gases. In one embodiment, an inert gas blanket can be used. Unprocessed crude also tends to have undesirable components such as bottom or base sediment waste (BSW) which can build up along the outer flux cartridge 1210 perimeter in the fluid ring 1220. Such build-up is especially likely to occur at the first filter pod or when there is a step change to a filter pod having a flux cartridge membrane with a smaller micron filter matrix. As a result, the first filter pod to process crude or the first filter pod where there is a step change in the micron size of the filter matrix, may function more as a filter than a cavitation device. Such build-up material can be backflushed by a pressure exerted, for example, by a first pneumatic ejector 2251 through the flux cartridge 2210 and into the fluid ring 2220.

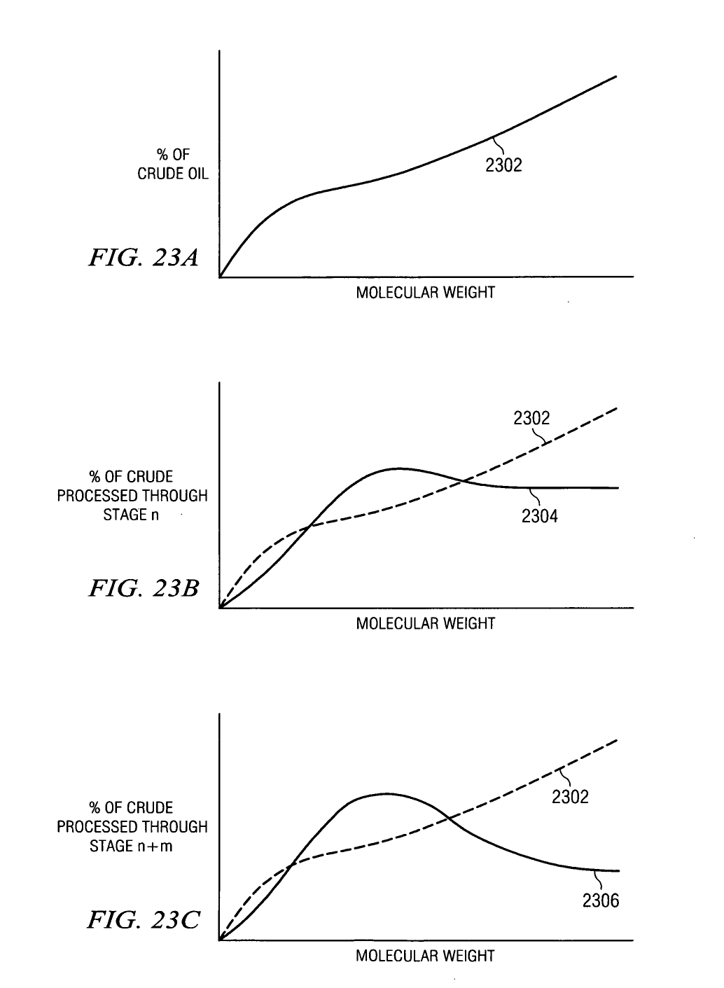

FIG. 23A is a graph depicting the distribution percentage of an unprocessed crude oil as a function of its molecular weight. Crude oil is a mixture of compounds of varying molecular weights. It should be noted that this graph is merely for illustration of the present invention that crude oils can vary significantly. The curve 2302 representing unprocessed crude oil indicates that unprocessed crude oil can have a relatively low percentage of desirable, lighter components and a relatively higher percentage of less desirable, heavier components. There is typically more demand for lower molecular weight, lighter components. It is thus necessary to convert the heavier components to lighter components through traditional, expensive refining operations. However, as previously noted, many refineries are unable to process heavier crude oils, and special blending may be required to even transport the heavier crude to a refinery.

FIG. 23B is a graph depicting the boiling point distribution of a crude processed through n stages in series having the same micron size in accordance with one embodiment of the present invention. The curve 2304 representing a processed crude oil indicates a shift in the distribution towards lower molecular weight components. The dashed curve 2302 representing unprocessed crude oil from FIG. 23A is shown for purposes of easy comparison. As shown in FIG. 23B, there is clearly a higher distribution of lighter molecular weight components and a lower distribution of undesirable relatively heavier molecular weight components. Additionally, the processed crude oil curve 2304 slope tends to flatten out in areas indicating higher molecular weight components perhaps indicating a correlation between an upper end molecular weight limit, hydrocarbon chain length, and/or molecular structural limit that is achieved with the micron size of the filter cartridge membrane used at stage n.

FIG. 23C is a graph depicting the boiling point distribution of a crude processed through n+m stages in accordance with one embodiment of the present invention. Stage n represents a number of stages of a first micron size and Stage m represents a number of stages in series with a smaller, second micron size. Thus, the crude is first processed through a series of n number of flux cartridges having a first membrane size, such as 40 microns and is then processed through a series of m number of flux cartridges having a second, smaller membrane size, such as 10 microns. Clearly, the number of stages and progressively smaller sized flux cartridge membranes can be employed to obtain the desired results. The curve 2306 representing a processed crude oil indicates a further shift in the distribution towards increased percentages of lower molecular weight components. The dashed curve 2302 representing unprocessed crude oil from FIG. 23 is shown for purposes of easy comparison. As occurred after the processing illustrated by FIG. 23B, the processed crude oil curve, 2306 slope tends to flatten out at a relatively lower level than the previously processed crude as illustrated by the curve 2304, in areas indicating higher molecular weight components perhaps indicating an upper end molecular weight limit, hydrocarbon chain length, and/or molecular structural limit that is achieved with the micron size of the filter cartridge membrane used at stage m.

Again, although not explicitly shown in FIG. 22, each filter pod or separator annulus device (2201-2208) can represent eight separator annulus devices in parallel and such arrangement may be referred to as a “Q-pod”. (See FIG. 9B) In one embodiment, the first Q-Pod 2201 is comprised of eight annulus devices in parallel. Similarly, the remaining Q-Pods 2202-2208 are comprised of eight annulus devices in parallel.

In the embodiment shown, the pumps and ejectors pneumatically operate at different time intervals that cycle between a filtration cycle (when the pumps P are operating) and an ejection cycle (when the ejectors E are operating). For example, the filtration cycle can occur for a pre-determined amount of time and at the end of this pre-determined amount of time, the Q-pod can be backwashed with a reverse flush from the ejector E. In alternative embodiments, variables other than time and/or in conjunction with time can be used to determine when the cycle interval. One such variable may be an average pressure differential that develops across the flux cartridges 2210 of the Q-pod. The BSW from the first Q-pod 2201 can be then sent to a settling tank where the undesirable solids, such as dirt and sediment, can be removed. The heavier hydrocarbons that failed to pass through the flux cartridge 2210 can then be routed back to the first Q-pod 2201 for re-processing.

The effluent 2211 exiting the flux cartridge 2210 from the first Q-pod is routed to a second Q-pod 2202 during a filtration cycle and enters the second Q-pod 2202 fluid ring 2220. As occurs in the first Q-pod, the crude is forced through the flux cartridge membrane 2210 in a turbulent manner and causes breakdown of the relatively heavier crude into a lighter crude with a higher API gravity. In one embodiment, the filtration cycle causes an average pressure drop across the flux cartridge membrane of between about 30 and 50 PSI and the ejection cycle causes an average pressure drop across the flux cartridge of between about 100 and 300 PSI. Surprisingly, when backpressure is applied during the ejection cycle (e.g., by the first ejector 2251) further cracking of crude occurs and the fluid ring effluent 2221 from the second Q-pod 2202 can have an average molecular weight lower than the effluent 2211 that entered the second Q-pod 2202. Preliminary tests have indicated that additional cracking of the crude can occur during the ejection cycle than in the filtration cycle. This may be due to the vigorous cavitation that occurs in the filter media and its vicinity by rapid changes in directional pressure between the filtration cycle and ejection cycle. Thus, the fluid ring effluent 2221 exiting the second separator annulus is partially enhanced and can be processed further by, for example, being routed back to the first separator annulus 2201 and/or to a concentrator in a manner suggested in the discussion surrounding FIG. 4 above. The filtration and ejection cycles can continue through a third Q-pod 2203, fourth Q-pod 2204, fifth Q-pod 2205, sixth Q-pod 2206, seventh Q-pod 2207 and eighth Q-pod 2208 as desired. It should be pointed out that the filtration cycles and ejection cycles can be optimized based upon the type of crude available for processing the desired profile of the resultant enhanced oil.

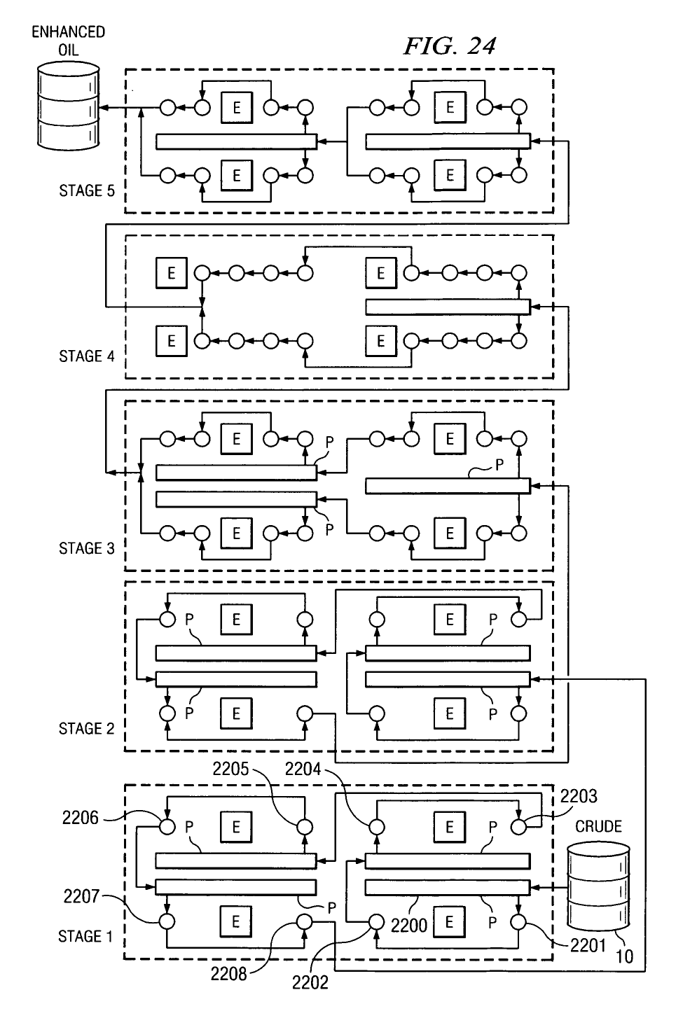

FIG. 24 is a schematic diagram depicting multiple stages in accordance with one embodiment of the present invention. The embodiment comprises five stages and can enhance and increase the API gravity of 5,000 barrels per day of crude. The first stage is identical to the process depicted and described above in reference to FIG. 22. Each Q-pod in stage 1 comprises a flux cartridge 2210 having a 40 micron filter matrix. Thus, stage 1 represents a total of eight Q-pods (64 separator annulus devices), four pumps P, and four ejectors E. Similarly, stage 2 comprises four pumps P, four ejectors E, and eight Q-pods. Each stage 2 Q-pod, however, comprises a flux cartridge having a 10 micron filter matrix. Stage 3 comprises three pumps, four ejectors, and sixteen 3-micron Q-pods. Stage 4 comprises one pump, four ejectors, and sixteen 0.5-micron Q-pods. Finally, stage 5 comprises two pumps, four ejectors, and sixteen 0.5 microns Q-pods. This system can effectively convert 5,000 barrels per day of petroleum having an 18 to 25 API gravity to enhanced oil having a 35 to 40 API gravity. The various configurations and stages depicted here are for purposes of illustration and not limitation. The system can be modified based upon the type of crude that is to be processed and the desired parameters of the resultant enhanced crude. Further, one skilled in the art would recognize that different configurations are possible depending upon such parameters.

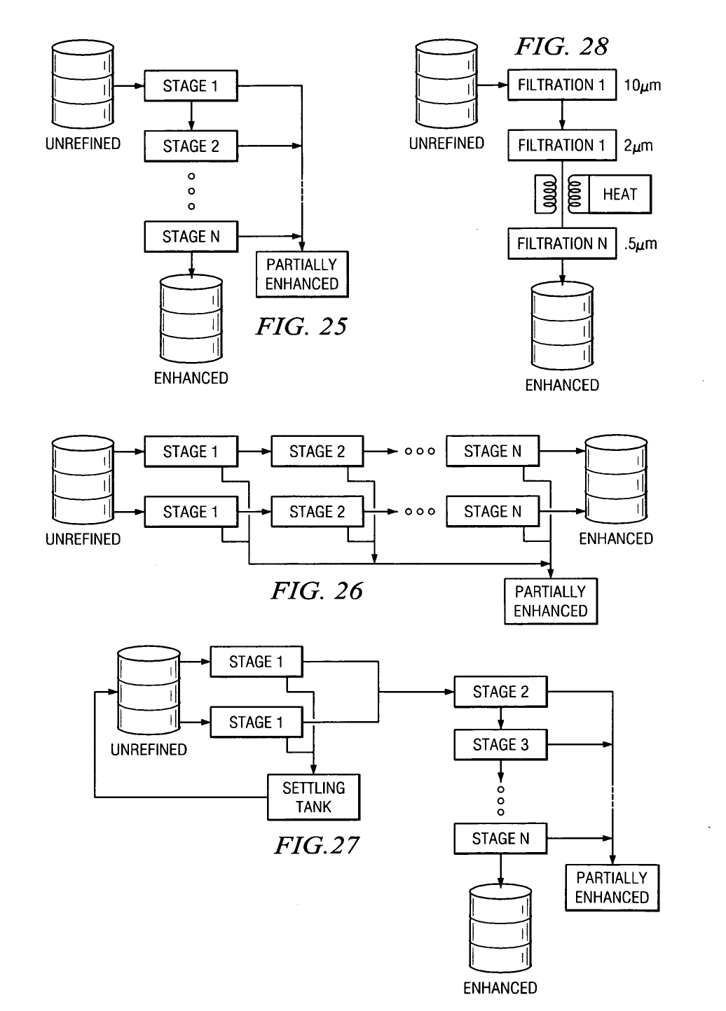

FIG. 25 is a schematic diagram of one embodiment of the present invention depicting multiple stages in series. Stages can be added as desired to further enhance or crack hydrocarbon compounds into smaller lowering boiling molecules having a higher API gravity.

FIG. 26 is a schematic diagram of one embodiment of the present invention depicting multiple stages in series and in parallel. This figure simply demonstrates that the capacity of unrefined crude being processed can be increased by adding stages in parallel. Also, the degree of enhancement and resultant hydrocarbon profile can be similarly controlled by adding stages as desired in series.

FIG. 27 is a schematic diagram of one embodiment of the present invention depicting multiple first stages in parallel and the remaining stages in series. Such an embodiment may be especially advantageous if there are large amounts of BSW in the crude that needs to be initially removed. Alternatively, it may be desirable to operate the filtration and ejection cycles at a much greater frequency in the earlier stages to further initially facilitate cracking of heavier crudes.

FIG. 28 is a schematic diagram depicting a decreasing filter membrane size and a heat source. Hydrocarbons may be better mobilized by heat provided by a heat source to lower the viscosity and enhance flow through the filter membranes. Such heat may be especially beneficial prior to routing the fluid through smaller filter membrane. Lowering the viscosity can also lower the resistivity of the fluid and permit BSW to settle out of solution where it can be easily backflushed during an ejection cycle into a settling tank.

In one embodiment, the filter membrane can comprise a catalyst (e.g. cobalt-molybdenum, alumina, aluminosilicate zeolite, palladium, platinum, nickel, rhodium, etc.) to further facilitate hydrocarbon cracking. In one embodiment, a heated or non-heated gaseous stream can be used to facilitate the cracking process. For example, a heated air or oxygen stream can be added or a non-heated hydrogen stream can be added. The examples of heated and non-heated gases are provided for purposes illustration and not limitation.

The instant invention results in numerous advantages. First, it provides an efficient method for enhancing crude oil to ease the load on a refinery. Second, it provides a way to increase the API gravity of crude so that the crude can be handled by refineries that may not be designed to handle heavier crudes. Third, it can help to provide a more stable feed stock to a refinery thereby avoiding upsets that can result in expensive shutdowns, safety hazards, and environmental upsets. Fourth, it can be portable and skid-mounted and can be placed near a well head and enhance crude where needed to facilitate transport, etc. Fifth, it provides for a more economical overall refining operation. Sixth, it provides an economical way to process heavier crude.

While the invention has been particularly shown and described with reference to a preferred embodiment, it will be understood by those skilled in the art that various changes in form and detail may be made therein without departing from the spirit and scope of the invention.

I claim:

1. A system for improving a crude oil comprising:
(a) a filtration media;
(b) pressure means for forcing the crude oil through the filter means, wherein cavitation is created.

2. The system of claim 1 wherein the cavitation provide a necessary cracking energy to crack the crude oil.

3. The system of claim 1 wherein the pressure means produces between 150 and 300 psi.

4. The system of claim 1 further comprises a valved flow path wherein the valves in a first position allow the forward flow of the crude oil through the media and in a second position allow the reverse flow of the crude oil through the media.

5. The system of claim 4 wherein cavitation is produced in both the first and second valve positions.

6. The system of claim 1 wherein the crude oil is cracked and achieves a higher API gravity.

7. The system of claim 1 wherein the media is a flux cartridge.

8. The system of claim 1 wherein the pressure means achieves a turbulent flow of crude oil through the media.

9. The system of claim 1 wherein the cavitation also produces flocculation of non hydrocarbon components in the crude oil.

10. A process for increasing the API gravity of a crude oil comprising the steps of:
(a) supplying a crude oil;
(b) providing a first pressure to a first side of a filter to force said crude oil through said filter.
(c) providing a second pressure to a second side of said filter; and
(d) forcing the crude oil through the filter to produce cavitation.

11. The process of claim 10 wherein the crude oil is cracked by the cavitation.

12. The process of claim 10 wherein step (d) comprises forcing the crude oil through a flux cartridge.

13. The process of claim 10 wherein the cavitation produces bubbles and the collapse of said bubbles produces high localized heat.

14. The process of claim 10 wherein the cavitation is produced during a backflow of the crude oil through the filter.

15. The process of claim 10 further comprises forcing the crude oil through a series of filters.

16. The process of claim 15 wherein each subsequent filter has a smaller porosity.

17. The process of claim 10 wherein step (d) comprises forcing the crude oil through a sintered metal filter with a 40 micron porosity.

18. The process of claim 10 further comprises repeating steps (a) to (d) until a desired API gravity is achieved.

19. The process of claim 10 wherein a waste stream is expelled from the crude oil.

20. The process of claim 10 further comprises adding heat to the crude oil during the process.
